(19) United States
(12) Patent Application Publication
(10) Pub. No.: US 2010/0036657 A1
(43) Pub. Date: Feb. 11, 2010

(54) SPEECH ESTIMATION SYSTEM, SPEECH ESTIMATION METHOD, AND SPEECH ESTIMATION PROGRAM

(76) Inventors: Mitsunori Morisaki, Tokyo (JP); Kenichi Ishii, Tokyo (JP)

Correspondence Address: DICKSTEIN SHAPIRO LLP, 1633 Broadway, NEW YORK, NY, 10019, US

(21) Appl. No.: 12/515,499

(22) PCT Filed: Nov. 20, 2007
(86) PCT No.: PCT/JP2007/072445

§ 371 Date: May 19, 2009

(30) Foreign Application Priority Data
Nov. 20, 2006 (JP) 2006-313309

(51) Int. Cl. G10L 11/00; G10L 15/00

(52) U.S. Cl. 704/206; 704/270; 704/231; 382/100; 704/E11.006; 704/E15.001

(57) ABSTRACT

The speech estimation system of the present invention includes a transmitter (2) for transmitting a test signal, a receiver (3) for receiving the test signal, and a speech estimation unit (4) for estimating speech from a received signal. Transmitter (2) transmits the test signal toward speech organs, receiver (3) receives the test signal that has been reflected by the speech organs, and speech estimation unit (4) estimates speech or speech waveforms based on the waveform of the reflection wave of the test signal that was received by the receiver (3).

### TECHNICAL FIELD

The present invention relates to the technical field for estimating human speech, and more particularly, relates to a speech estimation system and speech estimation method for estimating speech or speech waveforms from the movement of speech organs, and to a speech estimation program for causing a computer to execute this method.

### BACKGROUND ART

In recent years, techniques are being investigated for communicating without speech or, when vocalized, by whispering in an extremely low voice. Of this research, techniques for communication without vocalization can be broadly divided between two speech estimation methods: the image processing type and the biological signal acquisition type.

Image-processing speech estimation methods include methods that employ a camera, echoes (ultrasonography), MRI (Magnetic Resonance Imaging), or CT (Computerized Tomography) scans to acquire the shape or movement of the mouth or tongue. Examples of these methods are disclosed in JP-A-S61-226023, the document “Inside the Mouth: Using of Ultrasonography for Analyzing Dynamics of the Speech Organs (Nakajima Yoshitaka, Phonetics Society of Japan, 2003, Vol. 7, No. 3, pp. 55-66), and the document “Study of Reading Lips by Optical Flow” (Takeda Kazuhiro, et. al, 2003 PC Conference).

Biological signal acquisition speech estimation methods include a method of using electrodes to acquire electromyography signals and a method of using a fluxmeter to acquire action potentials. An example of these methods is disclosed in the document “Interface Technology concerning Biological Information” (Ninjouji Takashi, et. al, NTT Technical Review, September 2003, p. 49).

Finally, as a method of controlling sound without vocalization, a musical sound control device for controlling musical sounds of an electronic musical instrument by introducing a test sound inside the mouth and then using the response sound to this test sound that comes from the mouth. An example of this method is disclosed in Japanese Patent No. 2687698.

### DISCLOSURE OF INVENTION

However, a speech estimation method that uses a camera is problematic because special markings or lights must be used for extracting the position or shape of the mouth, and because the movement of the tongue or active states of the muscles that are important in vocalization are not understood.

A speech estimation method that uses echoes suffers from the problem that a transceiver for capturing echoes must be attached to the lower jaw. In contrast to a case of placing earphones on the ears, users are not accustomed to devices on the lower jaw and mounting a device on the lower jaw inevitably causes an unnatural sensation.

A speech estimation method that uses MRI or a CT scan are problematic because some people, such as pregnant women or people with pacemakers, are unable to these methods.

A speech estimation method that uses electrodes, similar to the case of using echoes, entails the problem that electrodes must be placed near the mouth. Unlike wearing earphones, fixing a device in the area of the mouth inevitably causes discomfort because people are unused to wearing devices around the mouth.

A speech estimation method that uses a fluxmeter is problematic due to the necessity for an environment that allows accurate acquisition of extremely low magnetism that is less than 1/1,000,000,000^{th} the magnetic force of terrestrial magnetism.

The musical sound control device described in the previously mentioned Japanese Patent No. 2687698 is a device for controlling musical sounds of an electronic musical instrument and does not take into consideration the control of speech and therefore discloses nothing regarding technology for estimating speech from a response sound from the mouth (i.e., reflection waves).

It is an object of the present invention to provide a speech estimation system, a speech estimation method, and a speech estimation program that enable the estimation of speech from the movement of speech organs without vocalization and without installing a special apparatus in the vicinity of the mouth.

The speech estimation system according to the present invention is for estimating speech or speech waveforms from the shape or movement of speech organs and includes: a transmitter for transmitting a test signal toward the speech organs, a receiver for receiving the reflection signal from the speech organs of the test signal that is transmitted by the transmitter, and a speech estimation unit for estimating speech or a speech waveform based on the reflection signal received by the receiver.

In addition, the speech estimation method according to the present invention is for estimating speech or a speech waveform from the shape or movement of speech organs and includes steps of: transmitting a test signal toward the speech organs, receiving the reflection signal of the test signal from the speech organs, and estimating speech or a speech waveform based on the reflection signal that was received.

In addition, the speech estimation program according to the present invention is for estimating speech or speech waveforms from the shape or movement of the speech organs and causes a computer to execute processes of estimating speech or a speech waveform based on a received waveform that is the waveform of a reflection signal of a test signal that was transmitted to be reflected by the speech organs.

According to the present invention, a test signal is transmitted toward the speech organs, the reflection signal of the test signal is received, and speech or a speech waveform is estimated from the received signal that is received, whereby information indicating the shape or movement of the speech organs that characterize speech can be obtained as the waveform of the reflection signal and speech or a speech waveform can be estimated based on the correlation between the waveform of the reflection signal and speech or a speech waveform. Accordingly, speech can be estimated from the movement of speech organs without vocalization even when a special apparatus is not placed in the area of the mouth.

### BRIEF DESCRIPTION OF DRAWINGS

FIG. 1 is a block diagram showing an example of the configuration of the speech estimation system according to the first exemplary embodiment of the present invention;

FIG. 2 is a flow chart showing an example of the operation of the speech estimation system according to the first exemplary embodiment;

FIG. 3 is a block diagram showing an example of the configuration of speech estimation unit 4;

FIG. 4 is a flow chart showing an example of the operation of the speech estimation system that includes speech estimation unit 4 shown in FIG. 3;

FIG. 5 is an explanatory view showing an example of the information that is registered in the received waveform-speech waveform correspondence database;

FIG. 6 is a block diagram showing an example of the configuration of speech estimation unit 4;

FIG. 7 is a flow chart showing an example of the operation of the speech estimation system that includes speech estimation unit 4 shown in FIG. 6;

FIG. 8 is an explanatory view showing an example of the information that is registered in the received waveform-speech correspondence database;

FIG. 9A is an explanatory view showing an example of the information that is registered in the received waveform-speech correspondence database;

FIG. 9B is an explanatory view showing an example of the information that is registered in the received waveform-speech correspondence database;

FIG. 9C is an explanatory view showing an example of the information registered in the received waveform-speech correspondence database;

FIG. 10 is an explanatory view showing an example of the information that is registered in the speech-speech waveform correspondence database;

FIG. 11 is a block diagram showing an example of the configuration of speech estimation unit 4;

FIG. 12 is a flow chart showing an example of the operation of the speech estimation system that includes speech estimation unit 4 shown in FIG. 11;

FIG. 13 is an explanatory view showing an example of the information that is registered in the received waveform-speech organ shape correspond database;

FIG. 14 is an explanatory view showing an example of the information that is registered in the speech organ shape-speech waveform correspondence database;

FIG. 15 is a block diagram showing an example of the configuration of speech estimation unit 4;

FIG. 16 is a flow chart showing an example of the operation of the speech estimation system that includes speech estimation unit 4 shown in FIG. 15;

FIG. 17 is an explanatory view showing an example of the information that is registered in the speech organ shape-speech correspondence database;

FIG. 18 is a block diagram showing an example of the configuration of the speech estimation system according to the second exemplary embodiment;

FIG. 19 is a flow chart showing an example of the operation of the speech estimation system according to the second exemplary embodiment;

FIG. 20 is a block diagram showing an example of the configuration of speech estimation unit 4 according to the second exemplary embodiment;

FIG. 21 is a flow chart showing an example of the operation of the speech estimation system that includes speech estimation unit 42 shown in FIG. 20;

FIG. 22 is a block diagram showing an example of the configuration of speech estimation unit 4 according to the second exemplary embodiment shown in FIG. 22;

FIG. 23 is a flow chart showing an example of the operation of the speech estimation system that includes speech estimation unit 4 shown in FIG. 22;

FIG. 24 is a block diagram showing an example of the configuration of the speech estimation system according to the third exemplary embodiment;

FIG. 25 is a flow chart showing an example of the operation of the speech estimation system according to the third exemplary embodiment;

FIG. 26 is a flow chart showing another example of the speech estimation system according to the third exemplary embodiment;

FIG. 27 is a block diagram showing an example of the configuration of personal-use speech estimation unit 4′;

FIG. 28 is a flow chart showing an example of the operation of the speech estimation system that includes personal-use speech estimation unit 4′ shown in FIG. 27;

FIG. 29 is a block diagram showing an example of the configuration of the speech estimation system according to the fourth exemplary embodiment;

FIG. 30 is a block diagram showing an example of the configuration of the speech estimation system according to the fourth exemplary embodiment; and

FIG. 31 is a flow chart showing an example of the operation of the speech estimation system according to the fourth exemplary embodiment.

### EXPLANATION OF REFERENCE NUMBERS

2 transmitter
3 receiver
4 speech estimation unit
4′ personal-use speech estimation unit
5 image acquisition unit
6 image analysis unit
7 speech acquisition unit
7′ personal-use speech acquisition unit
8 learning unit

### BEST MODE FOR CARRYING OUT THE INVENTION

Exemplary embodiments according to the present invention are next described with reference to the accompanying drawings.

### First Exemplary Embodiment

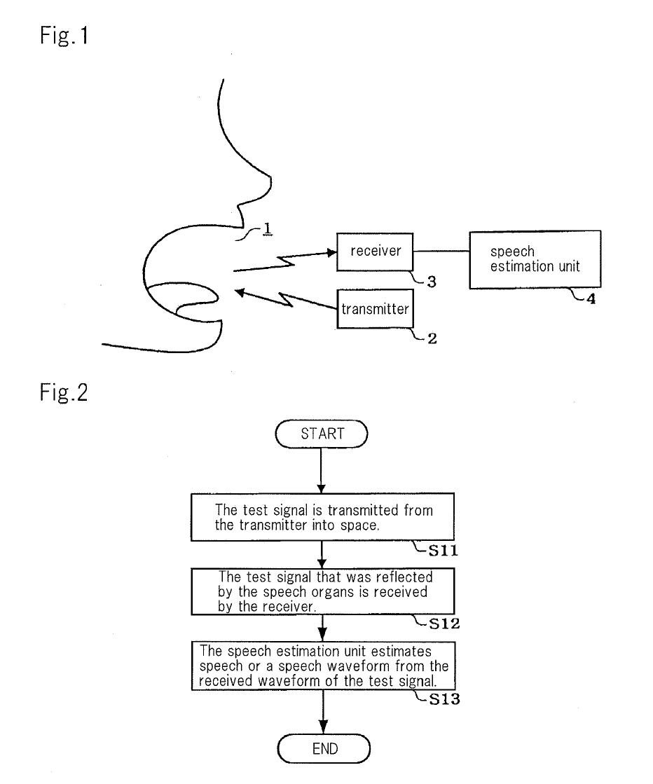

FIG. 1 is a block diagram showing an example of the configuration of the speech estimation system according to the first exemplary embodiment. As shown in FIG. 1, the speech estimation system includes transmitter 2 for transmitting a test signal into space; receiver 3 for receiving the reflection signal of the test signal that was transmitted by transmitter 2; and speech estimation unit 4 for estimating speech or a speech waveform from the reflection signal (hereinbelow referred to as simply “received signal”) that was received by receiver 3.

The test signal is transmitted toward the speech organs from transmitter 2, reflected by the speech organs, becoming a reflection signal by the speech organs, and received by receiver 3. The test signal may be, for example, an ultrasonic signal or an infrared signal.

In the present exemplary embodiment, “speech” refers to sounds emitted as spoken words, that refers to sounds, more specifically, indicated by any one of the elements of speech such as phonemes, vocal sounds, tone, sound volume, or voice quality or combinations of these elements. The speech waveform refers to one or a series of temporal waveforms of speech.

Transmitter 2 is a transmitter for transmitting a test signal such as an ultrasonic signal or an infrared signal. Receiver 3 is a receiver for receiving a test signal such as an ultrasonic signal or an infrared signal.

Speech estimation unit 4 is of a configuration that includes an information processing device such as a CPU (Central Processing Unit) that executes prescribed processes in accordance with a program and a memory device for storing programs. The information processing device may be a microprocessor that incorporates memory. Speech estimation unit 4 may be of a configuration that includes a database device and an information processing device that can connect to the database device.

In FIG. 1, an example is shown as a form of employing the speech estimation system in which transmitter 2 and receiver 3 as well as speech estimation unit 4 are arranged outside the mouth of the person that is the object of estimation of speech or speech waveforms and in which transmitter 2 transmits a test signal toward the cavity portion 1 formed by the speech organs. In addition, cavity portion 1 includes areas that are to be treated as speech organs such as the cavity portion itself, the oral cavity and the nasal cavities.

The operation of the speech estimation system in the present exemplary embodiment is next described with reference to FIG. 2. FIG. 2 is a flow chart showing an example of the operation of the speech estimation system according to the present exemplary embodiment.

Transmitter 2 first transmits the test signal toward the speech organs (Step S11). Here, the test signal is assumed to be an ultrasonic signal or an infrared signal. Transmitter 2 may transmit the test signal in accordance with manipulation from the person that is the target of speech or speech waveform estimation, or may transmit upon movement of the mouth of the person that is the target of estimation. Transmitter 2 transmits the test signal in a range that covers all of the speech organs. Speech is generated by the shape (and changes) of the speech organs such as the trachea, the vocal chords, and the vocal tract, and a test signal is therefore preferably transmitted that can obtain a reflection signal that reflects the shape (and changes) of the speech organs.

Depending on the elements of speech that are required as estimation results, not all of the shapes of the various organs that make up the speech organs need be reflected. For example, if only phonemes are to be estimated, only the shape of the vocal tract need be reflected.

And receiver 3 receives the reflection signal of the test signal that was reflected at the various points of the speech organs (Step S12). Speech estimation unit 4 then estimates speech or a speech waveform based on the waveform of the reflection signal (hereinbelow referred to as the “received waveform”) of the test signal that was received by receiver 3 (Step S13).

Transmitter 2 and receiver 3 may be incorporated in an article that can be placed near the face, such as a telephone, earphone, headset, decorative accessory, or eyeglasses. In addition, transmitter 2, receiver 3, and speech estimation unit 4 may be incorporated as a single unit in a telephone, earphone, headset, decorative accessory, or glasses. Still further, either of transmitter 2 and receiver 3 may be incorporated in a telephone, earphone, headset, decorative accessory, or eyeglasses.

Transmitter 2 and receiver 3 may be of an array structure configured as a single device by aligning a plurality of transmitters or a plurality of receivers at fixed intervals. Adopting an array structure enables high-power signal transmission to a limited area or reception of a weak signal from a limited area. Alternatively, varying the transmission or reception characteristics of each component within the array enables control of the transmission direction or the determination of the direction of origin of a received signal without moving the transmitter or receiver. In addition, at least one of transmitter 2 and receiver 3 may be incorporated in an apparatus requiring personal authentication such as an ATM.

Explanation next regards a specific example of the configuration of speech estimation unit 4 in the present exemplary embodiment as well as a specific example of the speech estimation operation in the present exemplary embodiment.

### Example 1

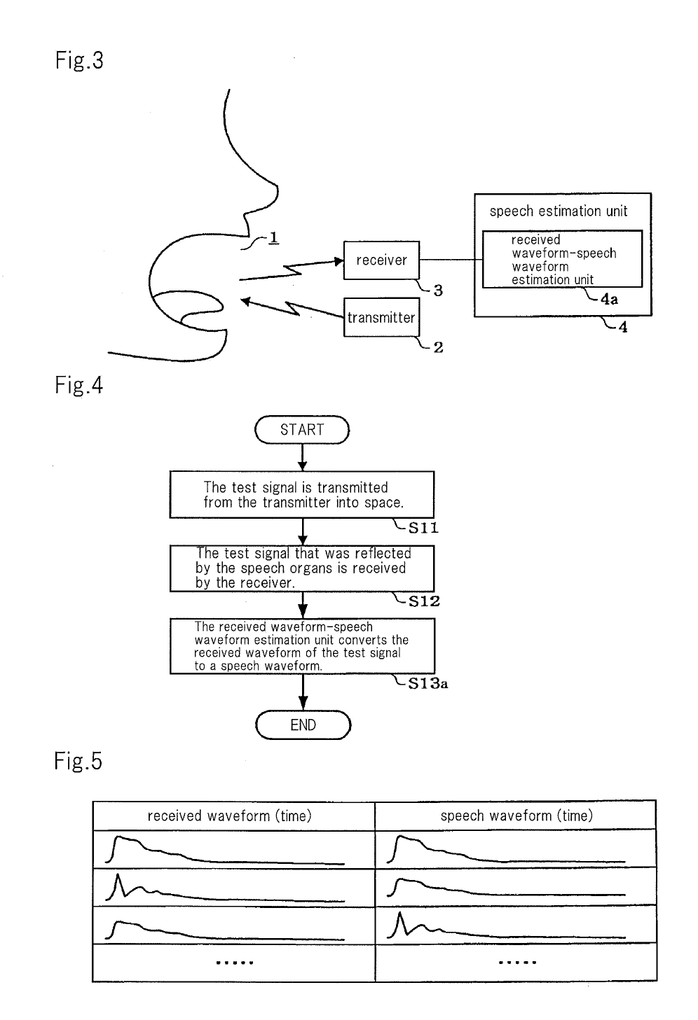

FIG. 3 is a block diagram showing an example of the configuration of speech estimation unit 4. As shown in FIG. 3, speech estimation unit 4 may include received waveform-speech waveform estimation unit 4a. Received waveform-speech waveform estimation unit 4a performs a process of converting a received waveform to a speech waveform.

FIG. 4 is a flow chart showing an example of the operation of the speech estimation system that includes speech estimation unit 4 according to the present example. The processes of Steps S11 and S12 are the same as the already-described operation and explanation of these steps is therefore here omitted. As shown in FIG. 4, the speech estimation system in this example operates as follows in Step S13 of FIG. 2. Received waveform-speech waveform estimation unit 4a of speech estimation unit 4 converts the received waveform that was received by receiver 3 to a speech waveform (Step S13a).

One example of the method for converting a received waveform to a speech waveform is a method that uses a received waveform-speech waveform correspondence database that holds the correspondence relations between received waveforms and speech waveforms.

Received waveform-speech waveform estimation unit 4a includes a received waveform-speech waveform correspondence database that stores received waveform information, which is waveform information of received waveforms when a test signal is reflected by speech organs, in a one-to-one correspondence with speech waveform information, which is waveform information of speech waveforms. Received waveform-speech waveform estimation unit 4a compares the received waveform that was received by receiver 3 with waveforms indicated by the received waveform information that is registered in the received waveform-speech waveform correspondence database and identifies the received waveform information that indicates the waveform having the highest degree of concurrence with the received waveform. The speech waveform indicated by the speech waveform information that is placed in correspondence with the identified received waveform information is then taken as the estimation result.

In this case, waveform information is information for identifying waveforms, and more specifically, is information that indicates the shapes or changes of waveforms or characteristic quantities of these shapes or changes. Spectral information is one example of information that indicates characteristic quantities.

FIG. 5 is an explanatory view showing an example of the information that is registered in the received waveform-speech waveform correspondence database.

As shown in FIG. 5, the received waveform-speech correspondence database stores waveform information of a received waveform that is obtained by reflection from speech organs when emitting a particular sound in correspondence with waveform information of the speech waveform that is the temporal waveform of speech that is emitted at the same time. FIG. 5 shows an example of storing received waveform information indicating the signal power with respect to time of a reflection signal that is obtained for the distinctive change in the shape of speech organs when the phoneme “a” is emitted and speech waveform information indicating the signal power with respect to time of a speech signal when the phoneme “a” is emitted. Information indicating spectral waveforms may be used as the waveform information.

As the method of comparing the received waveform and the waveform shown by the received waveform information that is registered in the database, typical comparison methods such as cross-correlation, the least squares method, or the maximum likelihood estimation method are used to convert the received waveform to the waveform in the database having the most similar shape. In addition, when the received waveform information registered in the database is a characteristic quantity that indicates the characteristic of a waveform, the same characteristic quantity may be extracted from the received waveform and the degree of concurrence then determined from the differences of the characteristic quantities.

Another example of a method of converting a received waveform to a speech waveform involves implementing a waveform conversion process upon the received waveform of the test signal to convert to a speech waveform.

Received waveform-speech waveform estimation unit 4a includes a waveform conversion filter unit for carrying out a prescribed waveform conversion process. As the waveform conversion process, the waveform conversion filter unit subjects the received waveform to at least one of an arithmetic process with a specific waveform, a matrix arithmetic process, a filter process, and a frequency-shift process to convert the received waveform to a speech waveform. These waveform conversion processes may be used separately or may be used in combination. Specific descriptions follow regarding each of the processes offered as waveform conversion processes.

In the case of an arithmetic process with a specific waveform, the waveform conversion filter unit multiplies a predetermined temporal waveform g(t) by a function f(t) that indicates the signal power with respect to time of the received waveform of the test signal that is received within particular time interval to find f(t)g(t). This result is taken as the speech waveform that is the estimation result.

In the case of a matrix arithmetic process, the waveform conversion filter unit multiplies a predetermined matrix E by function f(t) that indicates the signal power with respect to time of the received waveform of a test signal that is received within a particular time interval to find Ef(t). This result is taken as the speech waveform that is the estimation result. Alternatively, the waveform conversion filter unit may also multiply a predetermined matrix E by a function f(f) that indicates the signal power with respect to frequency of a received waveform (spectral waveform) of the test signal that is received within a particular time interval to find Ef(f).

In the case of a filter process, the waveform conversion filter unit multiplies a predetermined waveform (spectral waveform g(f)) by a function f(f) that indicates the signal power with respect to frequency of the received waveform (spectral waveform) of a test signal that is received within a particular time interval to find f(f)g(f). This result is taken as the speech waveform that is the estimation result.

In the case of a frequency-shift process, the waveform conversion filter unit adds or subtracts a predetermined frequency-shift amount “a” with respect to a function f(f) that indicates the signal power with respect to frequency of the received waveform (spectral waveform) of the test signal that is received within a particular time interval to find f(f-a). This result is taken as the speech waveform that is the estimation result.

### Example 2

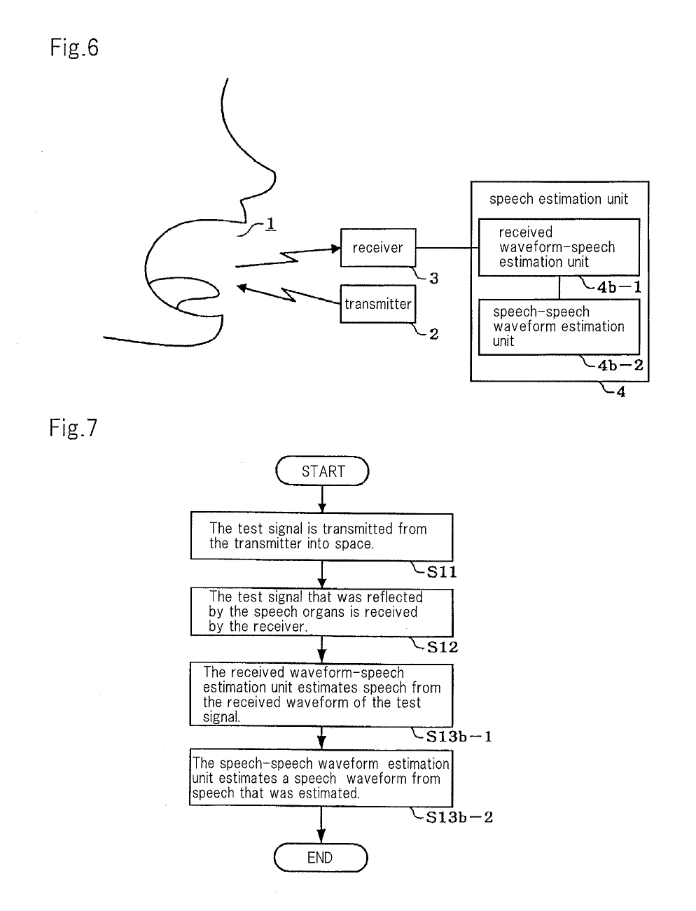

The present example is an example in which speech estimation unit 4 estimates speech from a received waveform and estimates a speech waveform from the estimated speech. FIG. 6 is a block diagram showing an example of the configuration of speech estimation unit 4.

As shown in FIG. 6, speech estimation unit 4 includes: received waveform-speech estimation unit 4b-1, and speech-speech waveform estimation unit 4b-2. Received waveform-speech estimation unit 4b-1 carries out a process of estimating speech based on the received waveform. Speech-speech waveform estimation unit 4b-2 carries out a process of estimating a speech waveform based on speech that was estimated by received waveform-speech estimation unit 4b-1. In addition, received waveform-speech estimation unit 4b-1 and speech-speech waveform estimation unit 4b-2 may be realized by the same computer.

FIG. 7 is a flow chart showing an example of the operation of the speech estimation system that includes speech estimation unit 4 according to this example. Steps S11 and S12 are identical to operation that has already been described and explanation is therefore here omitted.

As shown in FIG. 7, the speech estimation system in the present example operates as follows in Step S13 of FIG. 2. First, received waveform-speech estimation unit 4b-1 of speech estimation unit 4 estimates speech based on the received waveform that was received by receiver 3 (Step S13b-1). Speech-speech waveform estimation unit 4b-2 then estimates the speech waveform based on the speech that was estimated by received waveform-speech estimation unit 4b-1 (Step S13b-2).

One example of the method for estimating speech based on a received waveform is a method that uses a received waveform-speech correspondence database for holding cross-correlations of received waveforms and speech.

Received waveform-speech function unit 4b-1 includes a received waveform-speech correspondence database in which received waveform information is stored in a one-to-one correspondence with speech information that indicates speech. Received waveform-speech estimation unit 4b-1 compares a received waveform that was received by receiver 3 with waveforms that are indicated in the received waveform information registered in the received waveform-speech correspondence database to identify the received waveform information that indicates the waveform having the highest degree of concurrence with the received waveform. The speech indicated by the speech information that is placed in correspondence with the received waveform information that is identified is taken as the estimation result.

Here, the speech information is information for identifying speech, and more specifically, is identification information for identifying speech or information that indicates characteristic quantities of each of the elements that make up speech.

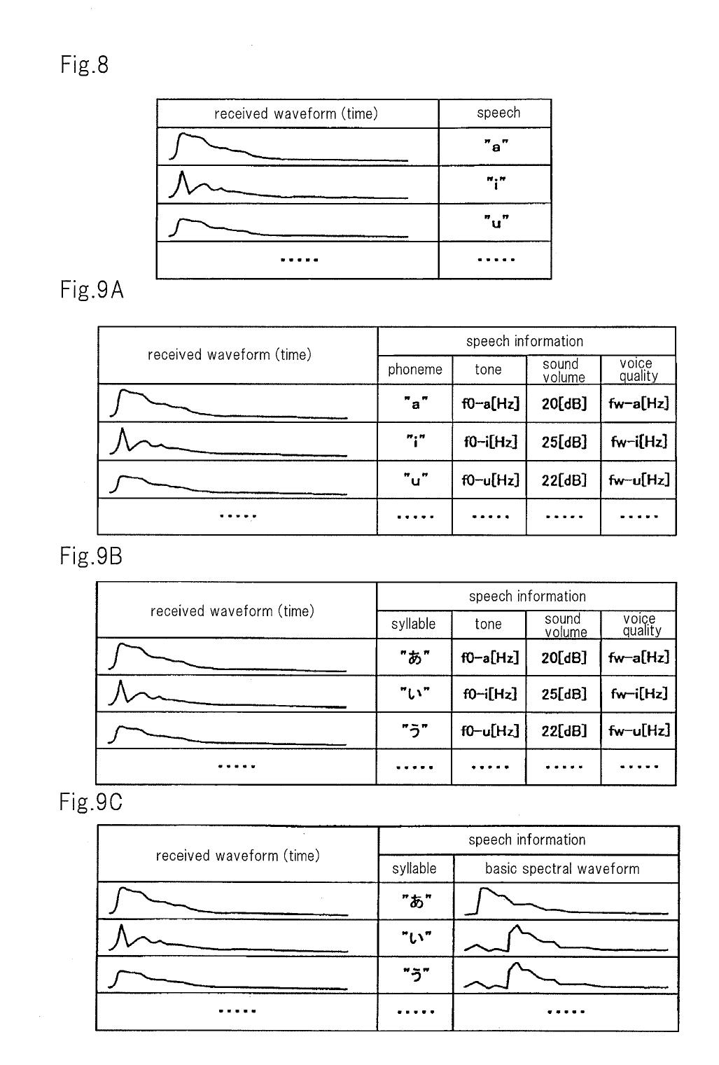

FIG. 8 is an explanatory view showing an example of information that is registered in the received waveform-speech correspondence database. As shown in FIG. 8, waveform information of a received waveform that is reflected by speech organs and obtained when a particular item of speech is uttered and speech information of speech that was uttered at that time are stored in correspondence with each other in the received waveform-speech estimation correspondence database. FIG. 8 shows an example of storing the received waveform information that indicates the signal power with respect to time of the reflection signal that is obtained for the characteristic shape changes of the speech organs when uttering, for example, the phoneme “a” and speech information for identifying the phoneme “a.”

Apart from phonemes (vocal sounds), the speech information may also be information that combines a plurality of elements such as syllables, tone, sound volume, and voice quality (sound quality).

FIGS. 9A to 9C show examples in which speech information that combines a plurality of elements is registered in received waveform-speech correspondence database. FIG. 9A is an example in which the information that is stored as speech information is obtained by combining information indicating phonemes, information indicating tone, information indicating sound volume, and information indicating voice quality.

FIG. 9B shows an example in which the information that is registered as speech information is obtained by combining information indicating syllables, information indicating tone, information indicating sound volume, and information indicating voice quality. This example shows a case in which an alphabet indicating the minimum units of sound in phonology is set as the information indicating phonemes, the Japanese syllabaries of hiragana and katakana are set as the information indicating syllables, basic frequencies are set as the information indicating tone, and spectral bandwidth is set as the information indicating voice quality. The speech information may also be spectral information that indicates the spectral waveforms of speech that serves as a reference.

In FIG. 9C, tone-sound volume-voice quality is represented as a single basic spectral waveform. The received waveform information is identical to the received waveform information that has already been described. In addition, the method of comparing a received waveform and waveforms indicated by the received waveform information that is registered in the database is also the same as the methods that have already been described.

As an example of a method of estimating a speech waveform from speech, one method uses a speech-speech waveform correspondence database for holding the correspondence relations between speech and speech waveforms.

Speech-speech waveform estimation unit 4b-2 includes a speech-speech waveform correspondence database for storing speech information in a one-to-one correspondence with speech waveform information. Speech-speech waveform estimation unit 4b-2 compares speech that has been estimated with speech indicated by speech information that is registered in the speech-speech waveform correspondence database and identifies the speech information that indicates the speech having the highest degree of concurrence. The speech waveform that is indicated by the speech waveform information that is placed in correspondence with the identified speech information is taken as the estimation result.

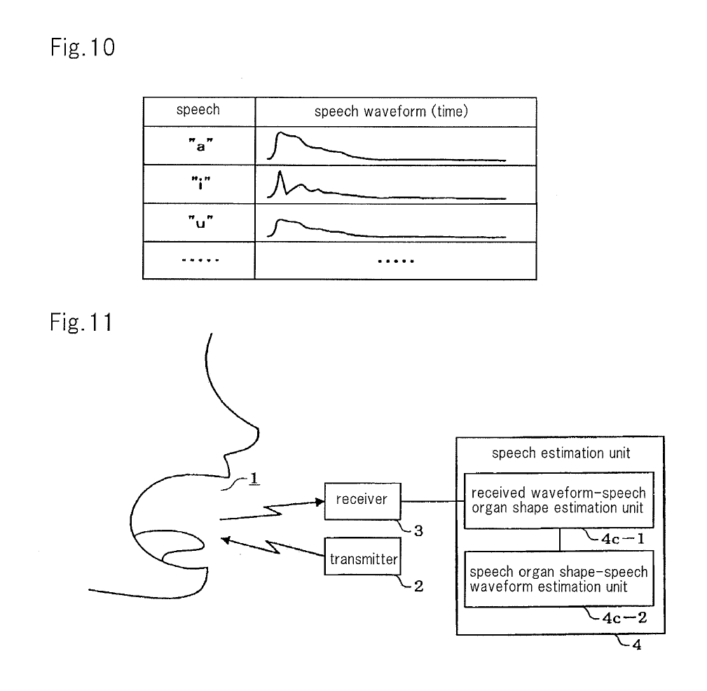

FIG. 10 is an explanatory view showing an example of information that is registered in the speech-speech waveform correspondence database.

As shown in FIG. 10, speech information for identifying, for example, the phoneme “a” is stored in the speech-speech waveform correspondence database in correspondence with speech waveform information that indicates the signal power with respect to time of a speech signal when the phoneme “a” is uttered. FIG. 10 shows an example in which temporal waveform information of speech is held for each item of speech information as speech waveform information. The speech information and speech waveform information are identical to the speech information and speech waveform information that have already been described.

The present example enables not only the estimation of a speech waveform but also the estimation of speech. This example can also be realized as a speech estimation system for estimating speech by omitting speech-speech waveform estimation unit 4b-2.

### Example 3

The present example is an example in which speech estimation unit 4 estimates speech organ shape based on the received waveform of a test signal, and then estimates the speech waveform based on the speech organ shape. FIG. 11 is a block diagram showing an example of the configuration of speech estimation unit 4.

As shown in FIG. 11, speech estimation unit 4 includes received waveform-speech organ shape estimation unit 4c-1 and speech organ shape-speech waveform estimation unit 4c-2. Received waveform-speech organ shape estimation unit 4c-1 carries out a process of estimating the shape of speech organs based on the received waveform. Speech organ shape-speech waveform estimation unit 4c-2 carries out a process of estimating speech waveform based on the shape of the speech organs that has been estimated by received waveform-speech organ shape estimation unit 4c-1. In addition, received waveform-speech organ shape estimation unit 4c-1 and speech organ shape-speech waveform estimation unit 4c-2 may be realized by the same computer.

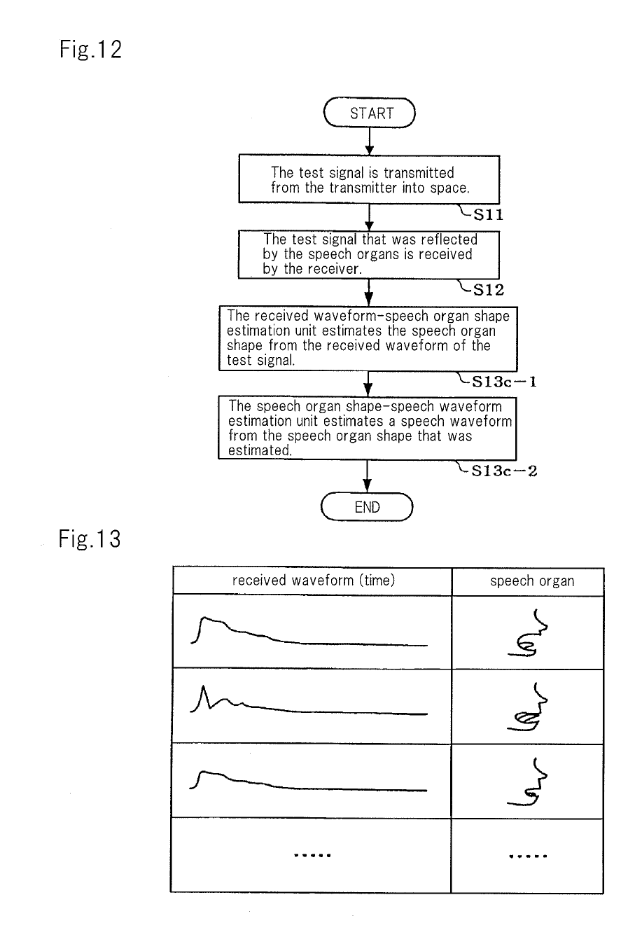

FIG. 12 is a flow chart showing an example of the operation of the speech estimation system that includes speech estimation unit 4 according to the present example. The operation of Steps S11 and S12 is identical to operation that has already been described and explanation is therefore here omitted.

As shown in FIG. 12, the speech estimation system in the present example operates as next described in Step S13 of FIG. 2. Received waveform-speech organ shape estimation unit 4c-1 of speech estimation unit 4 first estimates the speech organ shape based on the received waveform that was received by receiver 3 (Step S13c-1). Speech organ shape-speech waveform estimation unit 4c-2 then estimates the speech waveform based on the speech organ shape that was estimated by received waveform-speech organ shape estimation unit 4c-1 (Step S13c-2).

As one example of a method of estimating the shape of speech organs from a received waveform, a received waveform-speech organ shape correspondence database is used for holding the correspondence relations between received waveforms and the shapes of speech organs.

Received waveform-speech organ shape estimation unit 4c-1 includes a received waveform-speech organ shape correspondence database for storing received waveform information in a one-to-one correspondence with speech organ shape information that indicates the shapes (or the changes) of speech organs. Received waveform-speech organ shape estimation unit 4c-1 compares a received waveform that was received by receiver 3 with waveforms indicated by received waveform information that is registered in the received waveform-speech organ shape correspondence database and identifies the received waveform information that indicates the waveform having the highest degree of concurrence with the received waveform. The shape of the speech organs that is indicated by the speech organ shape information that is placed in correspondence with the received waveform information that was identified is taken as the estimation result.

FIG. 13 is an explanatory view showing an example of the information that is registered in the received waveform-speech organ shape correspondence database.

As shown in FIG. 13, the waveform information of a received waveform that has been reflected from the speech organs and obtained when uttering particular items of speech and speech organ shape information of speech organs at these times are stored in correspondence with each other in the received waveform-speech organ shape correspondence database. The present example shows an example of using image data as the speech organ shape information.

Examples of information that may be used as the speech organ shape information include: information indicating the positions of the various organs that make up the speech organs, information indicating the positions of reflectors in the speech organs, information indicating the position of each characteristic point, information indicating movement vectors at each characteristic point, and the values of each parameter in a propagation formula of sound waves in the speech organs. The received waveform information is identical to the received waveform information that has already been described. In addition, the methods of comparing a received waveform with waveforms indicated by the received waveform information that is registered in the database are also identical to the methods that have already been described.

In FIG. 13, image data of a mouth opened wide are registered in correspondence with the received waveform information that is registered first. This example shows that a received waveform that changes shape as is registered first is the received waveform that is obtained when the mouth shape is formed as shown by the image data and a sound uttered. The mouth shape that is shown by the image data in this case may include the shape of the lips and tongue.

As another example of the method of estimating the shape of speech organs based on the received waveform, one method estimates shape of speech organs by estimating the distance to various reflection points of speech organs based on the received waveform.

Received waveform-speech organ shape estimation unit 4c-1 identifies the position of each reflector in the speech organs based on the direction of incidence and the round-trip propagation time of the test signal that are indicated by the received waveform. Received waveform-speech organ shape estimation unit 4c-1 then uses the positions of the various reflectors that have been identified to measure the distance between the reflectors and thus estimate the shape of the speech organs as the aggregate of reflectors. In other words, knowing the round-trip propagation time of a reflection signal from a particular direction of incidence enables specification of the position of a reflector in that direction, and specifying the positions of reflectors in all directions then enables the estimation of the shape of the aggregate of the reflectors (in this case, the shape of the speech organs).

The process for estimating the shape of speech organs may be carried out by deriving a transfer function of sound waves in the speech organs. The transfer function may be derived by using a typical transfer model such as a Kelly speech generation model. When a reflection signal that has been reflected inside the speech organs is received by receiver 3, received waveform-speech organ shape estimation unit 4c-1 assigns the waveform (transmission waveform) of the test signal that was transmitted by transmitter 2 as input and assigns the waveform (received waveform) of the reflection signal that was received by receiver 2 as output in a prescribed transfer model expression. A transfer function of speech (sound waves within the speech organs from the vocal chords until speech waveforms are emitted outside the mouth) is derived by thus computing the parameters (such as coefficients) used in the transfer function.

When each of the coefficients used in the transfer function has a property of changing according to a particular value, the transfer function may be derived by finding this value (i.e., a parameter used in each coefficient) based on the property. For example, when the transfer function is expressed by the formula y=ax²+bx+c and coefficients a, b, and c have a relation that changes according to a particular value “k” as in a=k−1, b=k−5, and c=k−7, this value “k” may be computed as a parameter that is used in each coefficient.

Once the positions of the various organs that make up the speech organs or the positions of the reflectors within the speech organs have been estimated, the estimated positional relations may be used as a basis for deriving a transfer function by, for example, combining functions for specifying where sound waves from the vocal chords are reflected in the shape of the speech organs at that time and finding reflection waves at each reflection position.

One example of a method for estimating a speech waveform from the shape of speech organs involves the use of a speech organ shape-speech waveform correspondence database that holds the correspondence relations of the shapes of speech organs and speech waveforms.

Speech organ shape-speech waveform estimation unit 4c-2 includes a speech organ shape-speech waveform correspondence database for storing speech organ shape information in a one-to-one correspondence with speech waveform information. Speech organ shape-speech waveform estimation unit 4c-2 searches the speech organ shape-speech waveform correspondence database for the speech organ shape information that indicates the shape that is closest to the shape of the speech organs that was estimated by received waveform-speech organ shape estimation unit 4c-1. As a result of the search, the speech waveform indicated by the speech waveform information that is placed in correspondence with the speech organ shape information that was specified is taken as the estimation result.

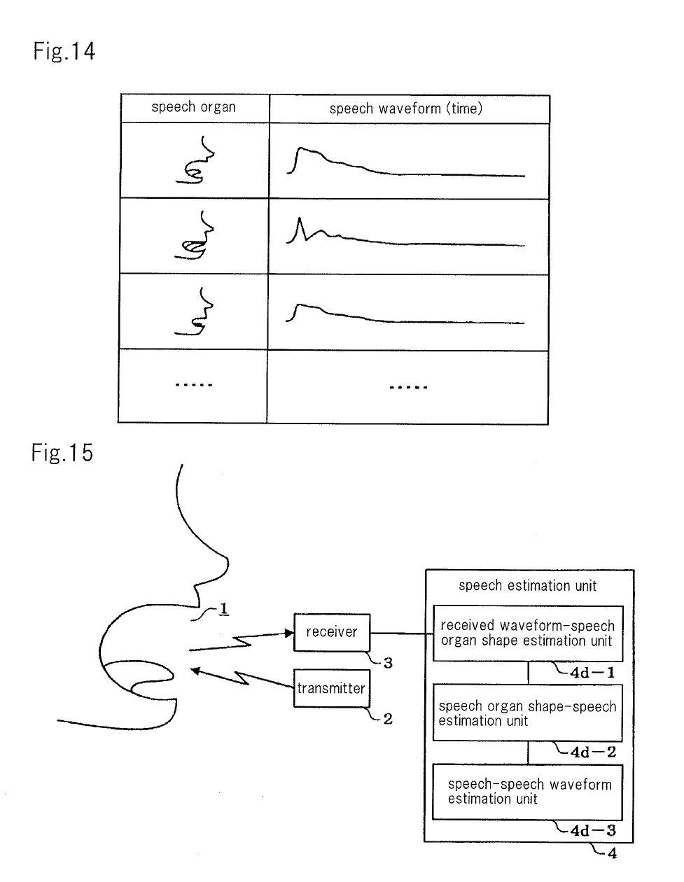

FIG. 14 is an explanatory view showing an example of the information that is registered in the speech organ shape-speech waveform correspondence database. As shown in FIG. 14, speech organ shape information of the speech organs when a particular sound is emitted is stored in speech organ shape-speech waveform correspondence database in correspondence with waveform information of the speech waveform when emitting that sound.

FIG. 14 shows an example of using image data as the speech organ shape information. Speech organ shape-speech waveform estimation unit 4c-2 uses a typical comparison method such as image recognition, matching at prescribed characteristic points, and the least squares method or the maximum likelihood estimation method at prescribed characteristic points to compare the shape of the speech organs that were estimated by received waveform-speech organ shape estimation unit 4c-1 and the shape of the speech organs that is indicated by the speech organ shape information registered in the speech organ shape-speech waveform correspondence database. The speech organ shape information may be information of only characteristic points. In addition, information indicating spectral waveforms may be used as the speech waveform information. As the result of comparison, speech organ shape-speech waveform estimation unit 4c-2 specifies the speech organ shape information having the most similar shape (for example, having the highest concurrence of characteristic quantities).

When received waveform-speech organ shape estimation unit 4c-1 derives a transfer function, speech organ shape-speech waveform estimation unit 4c-2 can use the transfer function that was derived to estimate the speech waveform. In addition, once a transfer function has been derived from the shape of speech organs that was estimated by received waveform-speech organ shape estimation unit 4c-1, speech organ shape-speech waveform estimation unit 4c-2 may estimate speech waveform using the derived transfer function.

One example of a method of estimating speech waveform from a transfer function involves using the waveform information of a sound source and the transfer function that was derived to supply the speech waveform.

Speech organ shape-speech waveform estimation unit 4c-2 includes a basic sound source information database for storing basic information of a sound source (sound source information) such as information indicating the waveforms emitted from a sound source. By assigning, as the input waveform in the derived transfer function, the sound source that is indicated in the sound source information that is held by the basic sound source information database, speech organ shape-speech waveform estimation unit 4c-2 computes the output waveform and takes this output waveform as the speech waveform.

### Example 4

The present example is a case in which speech estimation unit 4 estimates the speech organ shape from the received waveform of the test signal and, having estimated the speech from the speech organ shape that was estimated, then estimates the speech waveform based on the estimated speech.

FIG. 15 is a block diagram showing an example of the configuration of speech estimation unit 4. As shown in FIG. 15, speech estimation unit 4 includes received waveform-speech organ shape estimation unit 4d-1, speech organ shape-speech estimation unit 4d-2, and speech-speech waveform estimation unit 4d-3.

Received waveform-speech organ shape estimation unit 4d-1 is identical to received waveform-speech organ shape estimation unit 4c-1 that was described in Example 3, and detailed explanation of this component is therefore here omitted. Speech-speech waveform estimation unit 4d-3 is identical to speech-speech waveform estimation unit 4b-2 that was described in Example 2, and detailed explanation is therefore here omitted. Speech organ shape-speech estimation unit 4d-2 carries out a process for estimating speech from the shape of speech organs that was estimated by received waveform-speech organ shape estimation unit 4d-1.

Received waveform-speech organ shape estimation unit 4d-1, speech organ shape-speech estimation unit 4d-2, and speech-speech waveform estimation unit 4d-3 may be realized by the same computer.

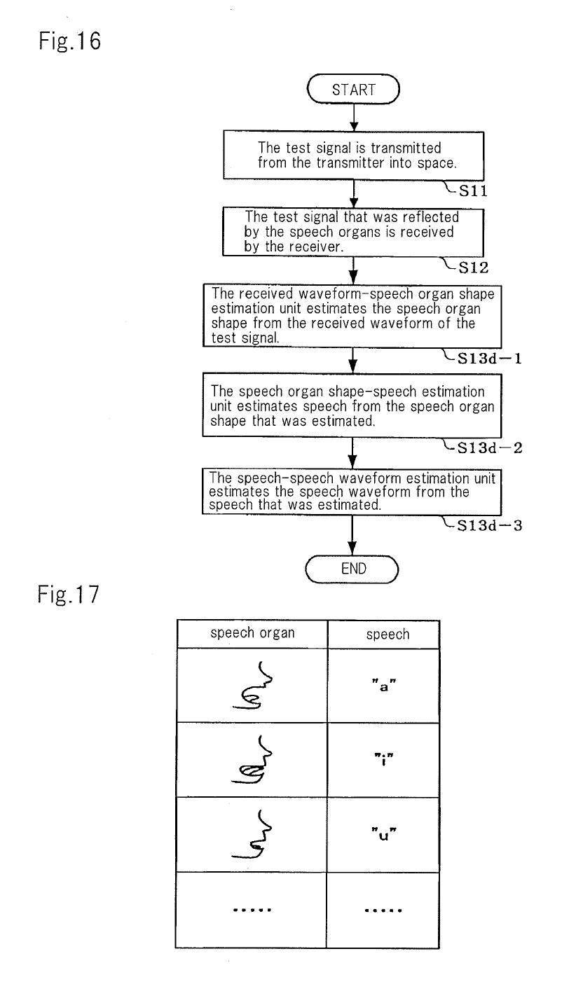

FIG. 16 is a flow chart showing an example of the operation of the speech estimation system that includes speech estimation unit 4 according to the present example. Here, the operation of Steps S11 and S12 is identical to the operation that has already been described and redundant explanation is therefore omitted.

As shown in FIG. 16, the speech estimation system in the present example operates as follows in Step S13 of FIG. 2. Received waveform-speech organ shape estimation unit 4d-1 of speech estimation unit 4 first estimates the speech organ shape based on the received waveform of the test signal (Step S13d-1). The operation in this step is identical to Step S13c-1 described in FIG. 12 and detailed explanation is therefore here omitted.

Speech organ shape-speech estimation unit 4d-2 next estimates speech based on the speech organ shape that was estimated by received waveform-speech organ shape estimation unit 4d-1 (Step S13d-2). Speech-speech waveform estimation unit 4d-3 then estimates the speech waveform based on the speech that was estimated by speech organ shape-speech estimation unit 4d-2 (Step S13d-3).

One example of the method for inferring speech from the shapes of speech organs in Step S13d-2 involves using a speech organ-speech correspondence database that saves the correspondence relations of the shapes of speech organs and speech.

Speech organ shape-speech estimation unit 4d-2 includes a speech organ shape-speech correspondence database for storing speech organ shape information in one-to-one correspondence with speech information. Speech organ shape-speech estimation unit 4d-2 estimates speech by searching the speech organ shape-speech correspondence database for speech organ shape information that indicates the shape that is closest to the shape of the speech organs that was estimated.

FIG. 17 is an explanatory view showing an example of the information that is registered in the speech organ shape-speech correspondence database. As shown in FIG. 17, speech organ shape information that indicates shapes of speech organs and changes in the shapes of speech organs that characterize speech is stored in correspondence with speech information of this speech in speech organ shape-speech correspondence database.

FIG. 17 shows a case in which image data are used as speech organ shape information. The method of comparing the shape of speech organs that has been estimated and the shapes of speech organs that are registered in the speech organ shape-speech correspondence database is identical to the methods that have already been described. More specifically, as a result of comparison, speech organ shape-speech estimation unit 4d-2 specifies the speech organ shape information having the most similar shape (for example, in which the characteristic quantity has the highest degree of concurrence).

This example enables not only estimation of the speech waveform but also speech. In addition, as in the configuration described in FIG. 6 of Example 2, speech-speech waveform estimation unit 4d-3 can be omitted and the present example can be operated as a speech estimation system for estimating speech.

According to the present exemplary embodiment as described hereinabove, by obtaining received waveforms by reflecting a test signal at speech organs, speech or speech waveforms can be estimated based on the received waveforms by carrying out a conversion process, search process, or arithmetic process based on the cross correlations between the received waveforms and speech or speech waveforms. Accordingly, speech can be estimated based on the movement of speech organs without vocalization even when a special apparatus is not installed near the mouth.

Incorporation of the present system in a portable telephone enables forms of use in which conversation is possible in a public space or a space in which silence is desired by merely moving one's mouth in front of the portable telephone. In such cases, conversation can be conducted without disturbing people in the vicinity, or conversation having extremely confidential or high-security (for example, business-related) content can be conducted without concern for someone who might be listening.

### Second Exemplary Embodiment

The present exemplary embodiment is next described with reference to the accompanying drawings.

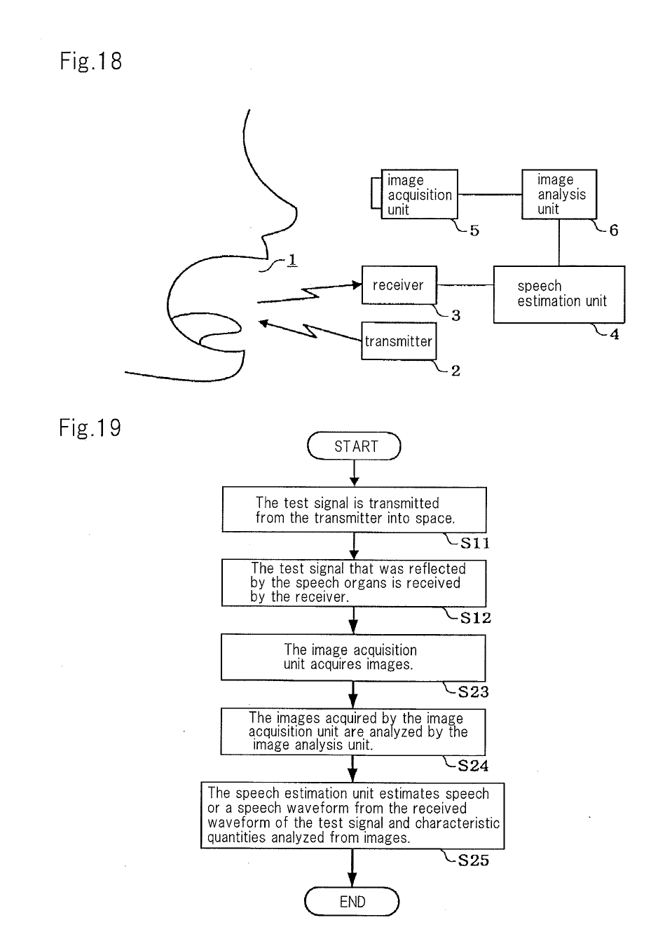

FIG. 18 is a block diagram showing an example of the configuration of the speech estimation system according to the present exemplary embodiment. As shown in FIG. 18, the speech estimation system according to the present exemplary embodiment is realized by adding image acquisition unit 5 and image analysis unit 6 to the configuration of the speech estimation system shown in FIG. 1.

Image acquisition unit 5 acquires images containing a portion of the person's face that is the target of speech or speech waveform estimation. Image analysis unit 6 analyzes the images that are acquired by image acquisition unit 5 and extracts characteristic quantities relating to the speech organs. In addition, speech estimation unit 4 in the present exemplary embodiment estimates speech or speech organs based on the received waveform of the test signal that was received by the receiver and the characteristic quantities that were analyzed by image analysis unit 6.

Image acquisition unit 5 is a camera device that includes a lens as a portion of its configuration. The camera device is provided with an image-capture element such as a CCD (Charge-Coupled Device) or a CMOS (Complementary Metal Oxide Semiconductor) image sensor that converts an image received as input by way of a lens to an electric signal. Image analysis unit 6 includes an information processing device such as a CPU for executing prescribed processes in accordance with a program and a storage device for storing programs. Images that are captured by image acquisition unit 5 are stored in the storage device.

The operation of the speech estimation system in the present exemplary embodiment is next described with reference to FIG. 19. FIG. 19 is a flow chart showing an example of the operation of the speech estimation system according to the present exemplary embodiment.

Transmitter 2 first transmits a test signal toward speech organs (Step S11). Receiver 3 receives the reflected wave of the test signal that was reflected at various points of the speech organs (Step S12). The transmission operation and reception operation of the test signal in Steps S11 and S12 are identical to the first exemplary embodiment and detailed explanation is therefore here omitted.

Parallel to the reception operation of the test signal, image acquisition unit 5 acquires images of at least a portion of the face of the person that is the target of speech or speech waveform estimation (Step S23). In this case, the subject's face or mouth serves as an example of the image that is acquired by image acquisition unit 5. “Mouth” here refers to the vicinity of the mouth and lips (such as the teeth and tongue).

Next, image analysis unit 6 analyzes the images acquired by image acquisition unit 5 (Step S24). Image acquisition unit 5 analyzes the images and extracts a characteristic quantity relating to the speech organs. Speech estimation unit 4 then estimates speech or speech waveforms based on the received waveform of the test signal that was received by receiver 3 and the characteristic quantity that was analyzed by image analysis unit 6 (Step S25).

Examples of methods of analyzing images in image analysis unit 6 include an analysis method of extracting from the outline of the lips a characteristic quantity that indicates the characteristics of the lips and an analysis method of extracting from the movement of the lips a characteristic quantity that indicates characteristics of lip movements.

Image analysis unit 6 uses a method of extracting a characteristic quantity that reflects the shape of the lips that takes a lip model as base or a method of extracting a characteristic quantity that reflects the shape of the lips that takes pixels (picture elements) as a base. More specifically, the following methods are used. One method uses the optical flow that is the apparent velocity distribution of brightness to extract movement information of the lips and the vicinity of the lips. Alternatively, in one method, the outline of the lips is extracted from within the image and statistically modeled, and the model parameters obtained from this process then extracted. In yet another method, information such as the brightness inherent to the pixels themselves in an image is directly subjected to a signal process such as a Fourier transform and the result taken as a characteristic quantity.

The characteristic quantity is not limited to the characteristic quantity that indicates the shape or movement of the lips, and characteristic quantities indicating the expression of the face, the movement of the teeth, the movement of the tongue, the outline of the teeth, or the outline of the tongue may be extracted. More specifically, characteristic quantities are the positions of the eyes, mouth, lips, teeth, and tongue, the positional relations of these features, position information indicating the movement of these features, or movement vectors that indicate the direction and distance of movement of these features. Alternatively, the characteristic quantity may be a combination of these values.

An explanation next follows regarding both an actual example of the configuration of speech estimation unit 4 in the present exemplary embodiment and the speech estimation operation in the present exemplary embodiment.

### Example 5

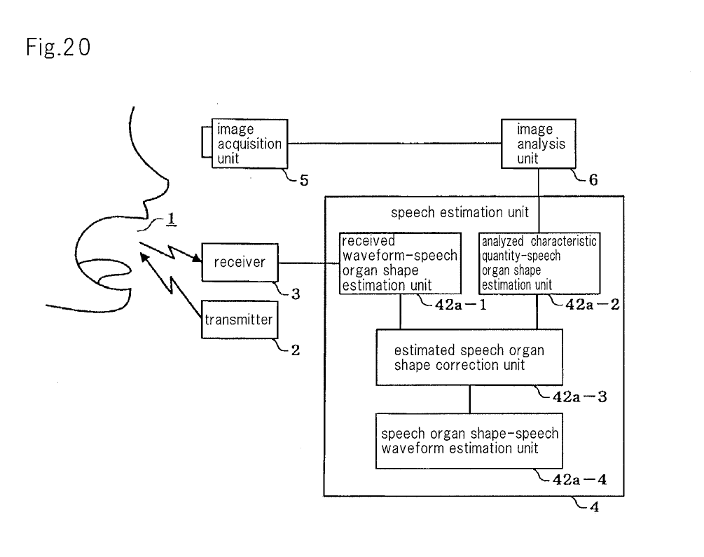

The present example is a case in which the estimation of a speech waveform is achieved by using an image to correct the estimation of the shape of speech organs. FIG. 20 is a block diagram showing an example of the configuration of speech estimation unit 4 in the present example.

As shown in FIG. 20, speech estimation unit 4 according to the present example includes received waveform-speech organ shape estimation unit 42a-1, analyzed characteristic quantity-speech organ shape estimation unit 42a-2, estimated speech organ shape correction unit 42a-3, and speech organ shape-speech waveform estimation unit 42a-4.

Received waveform-speech organ shape estimation unit 42a-1 is of the same configuration as received waveform-speech organ shape estimation unit 4c-1 described in example 3, and speech organ shape-speech waveform estimation unit 42a-4 is the same as speech organ shape-speech waveform estimation unit 4c-2 described in example 3. As a result, a detailed description of the configurations of these components is here omitted.

Analyzed characteristic quantity-speech organ shape estimation unit 42a-2 carries out a process for estimating the shape of speech organs from the characteristic quantities that were analyzed by image analysis unit 6. Estimated speech organ shape correction unit 42a-3 further carries out a process of correcting the shape of the speech organs that was estimated from the received waveform based on the shape of speech organs that was estimated from the characteristic quantities.

Received waveform-speech organ shape estimation unit 42a-1, analyzed characteristic quantity-speech organ shape estimation unit 42a-2, estimated speech organ shape correction unit 42a-3, and speech organ shape-speech waveform estimation unit 42a-4 may be realized by the same computer.

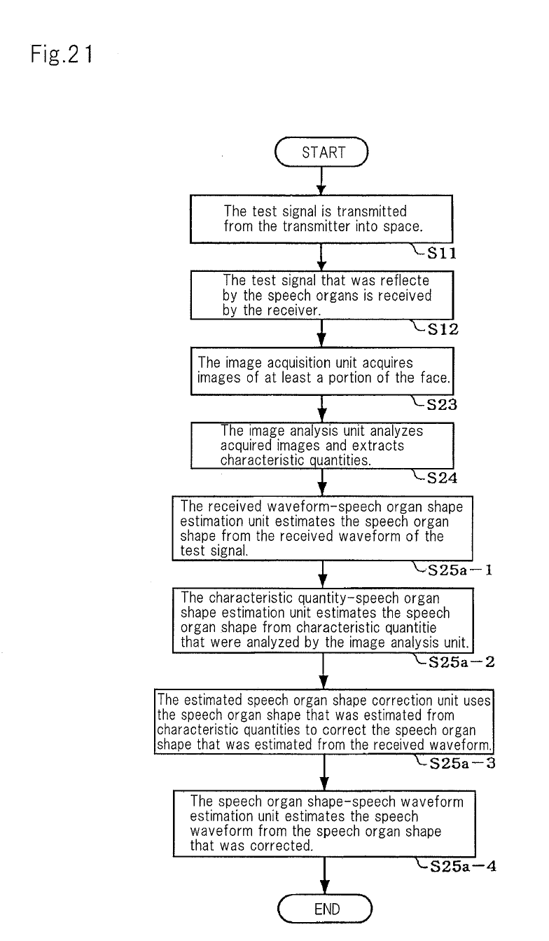

FIG. 21 is a flow chart showing an example of the operation of the speech estimation system that includes speech estimation unit 4 according to the present example. Here, the operation of Steps S11, S12, S23, and S24 is the same as the operation that has already been described and redundant explanation is therefore here omitted.

As shown in FIG. 21, the speech estimation system in the present example operates as next described in Step S25 of FIG. 19. Received waveform-speech organ shape estimation unit 42a-1 of speech estimation unit 4 first estimates the shape of speech organs from the received waveform of the test signal that was received by receiver 3 (Step S25a-1). Analyzed characteristic quantity-speech organ shape estimation unit 42a-2 then estimates the shape of the speech organs from the characteristic quantities that were analyzed by image analysis unit 6 (Step S25a-2).

When the shape of speech organs is estimated by each of received waveform-speech organ shape estimation unit 42a-1 and analyzed characteristic quantity-speech organ shape estimation unit 42a-2, estimated speech organ shape correction unit 42a-3 uses the shape of speech organs that was estimated by analyzed characteristic quantity-speech organ shape estimation unit 42a-2 to correct the shape of speech organs that was estimated by received waveform-speech organ shape estimation unit 42a-1 (Step S25a-3). In other words, using the shape of speech organs that was estimated from characteristic quantities, estimated speech organ shape correction unit 42a-3 corrects the shape of the speech organs that was estimated from the received waveform. Speech organ shape-speech waveform estimation unit 4c-2 then estimates the speech waveform from the shape of the speech organs that was corrected by estimated speech organ shape correction unit 42a-3 (Step S35a-4).

One example of the method for estimating the shape of speech organs from characteristic quantities that have been obtained from images involves a method of direct estimation of the shape of speech organs from characteristic quantities that were obtained from images. In this method, analyzed characteristic quantity-speech organ shape estimation unit 42a-2 estimates by converting values extracted as characteristic quantities to a three-dimensional shape. In this case, the characteristic quantities are items of information that indicate the movement or manner of opening of the lips and teeth, expressions, and movement of the tongue.

Another example of a method for estimating the shape of speech organs from characteristic quantities that are obtained from images employs an analyzed characteristic quantity-speech organ shape correspondence database that holds the correspondence relations of characteristic quantities obtained from images and shapes of speech organs.

Analyzed characteristic quantity-speech organ shape estimation unit 42a-2 includes an analyzed characteristic quantity-speech organ shape correspondence database for storing characteristic quantities obtained from images in one-to-one correspondence with speech organ shape information that indicates the shapes of speech organs. Analyzed characteristic quantity-speech organ shape estimation unit 42a-2 compares characteristic quantities that have been analyzed by image analysis unit 6 and characteristic quantities that are held in the analyzed characteristic quantity-speech organ shape correspondence database and specifies the characteristic quantity that has the highest degree of concurrence with the characteristic quantity obtained from images. The shape of the speech organs that is indicated by the speech organ shape information that is placed in correspondence with the characteristic quantity that was specified is taken as the estimated speech organ shape.

One method of correcting the speech organ shape involves computing the weighted mean of the speech organ shape that was estimated from characteristic quantities and the speech organ shape that was estimated from the received waveform of the test signal. Estimated speech organ shape correction unit 42a-3 carries out weighting that uses predetermined weights that indicate the reliability of each estimation result for the values of each of the elements in the propagation formula that indicates propagation of sound waves in the speech organs, such as the positions of the various organs that are indicated as the speech organ shape that is the estimation result, the positions of the reflectors in the speech organs, the positions of each characteristic point, and movement vectors at various characteristic points. The shape that is indicated by the speech organ shape information that was obtained as a result of obtaining the weighted mean is then taken as the corrected speech organ shape.

Estimated speech organ shape correction unit 42a-3 may use coordinate information as a method of correcting the speech organ shapes. For example, it is assumed that the coordinate information of a reflector in a particular direction indicated as the estimation result from received waveforms is (10, 20) and the coordinates of a particular point of a speech organ indicated by the characteristic quantity obtained from an image are (15, 25). Estimated speech organ shape correction unit 42a-3 implements 1:1 weighting of these two items of coordinate information to correct to the coordinate information ((10+15)/2, (20+25)/2).

As another example of a method of correcting speech organ shapes, one method uses an estimated speech organ shape database that holds correspondence relations of combinations of speech organ shapes estimated from characteristic quantities and speech organ shapes estimated from received waveforms and corrected speech organ shapes.

Estimated speech organ shape correction unit 42a-3 includes an estimated speech organ shape database for storing combinations of first speech organ shape information that indicates shapes of speech organs that are estimated from characteristic quantities that are obtained from images and second speech organ shape information that indicates shapes of speech organs that are estimated from received waveforms in correspondence with third speech organ shape information that indicates the shapes of speech organs after correction.

Estimated speech organ shape correction unit 42a-3 searches the estimated speech organ shape database for the combination of first speech organ shape information and second speech organ shape information that indicates the combination of shapes having the highest degree of concurrence to the combination of the shape of speech organs estimated from characteristic quantities obtained from images and the shape of speech organs estimated from a received waveform. As the result of the search, the shape of speech organs indicated by the third speech organ shape information that is placed in correspondence with the specified combination is taken as the correction result.

In the present example, a case was shown in which speech organ shape-speech waveform estimation unit 42a-4 estimates a speech waveform from the shape of speech organs that has been corrected, but the speech organ shape-speech estimation unit shown in the first exemplary embodiment may also be included in the configuration of the present example. In this case, speech can also be estimated from the shape of speech organs that has been corrected. In addition, the speech-speech waveform estimation unit described in the first exemplary embodiment may also be included in the configuration of the present example. In this case, a speech waveform can also be estimated from speech that has been estimated from the shape of speech organs that has been corrected.

According to the present example, in the process of estimating a speech waveform from a received waveform, not only is the shape of speech organs estimated from the received waveform, but the shape of speech organs is also estimated from characteristic quantities obtained from images. Then, having used each of the estimation results to correct the shape of speech organs, a speech waveform is estimated, whereby estimation of a speech waveform can be realized with higher reproducibility.

### Example 6

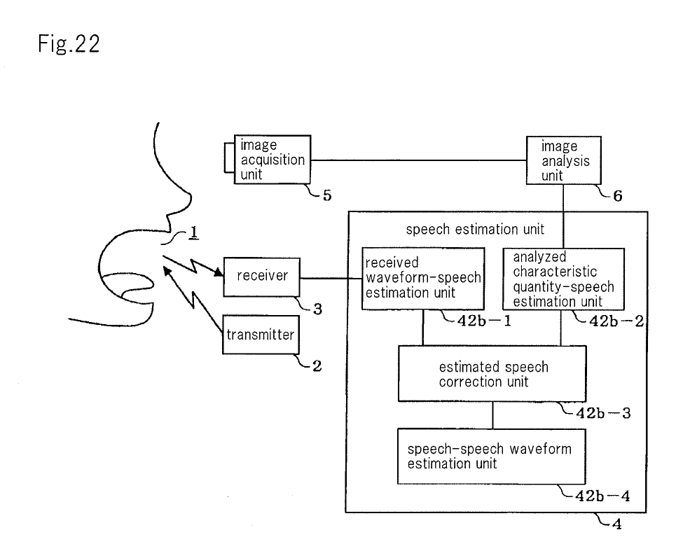

The present example is an example in which images are used to correct the estimation of speech to estimate a speech waveform. FIG. 22 is a block diagram showing an example of the configuration of speech estimation unit 4 according to the present example.

As shown in FIG. 22, speech estimation unit 4 according to the present example includes received waveform-speech estimation unit 42b-1, analyzed characteristic quantity-speech estimation unit 42b-2, estimated speech correction unit 42b-3, and speech-speech waveform estimation unit 42b-4.

Received waveform-speech estimation unit 42b-1 is of the same configuration as received waveform-speech estimation unit 4b-1 described in example 2, and speech-speech waveform estimation unit 42b-4 is the same as speech-speech waveform estimation unit 4b-2 described in example 2. As a result, detailed explanation of these components is here omitted.

Analyzed characteristic quantity-speech estimation unit 42b-2 carries out a process of estimating speech from characteristic quantities that have been analyzed by image analysis unit 6. Estimated speech correction unit 42b-3 carries out a process of correcting the speech that was estimated from received waveforms based on speech that was estimated from characteristic quantities.

Received waveform-speech estimation unit 42b-1, analyzed characteristic quantity-speech estimation unit 42b-2, estimated speech correction unit 42b-3, and speech-speech waveform estimation unit 42b-4 may be realized by the same computer.

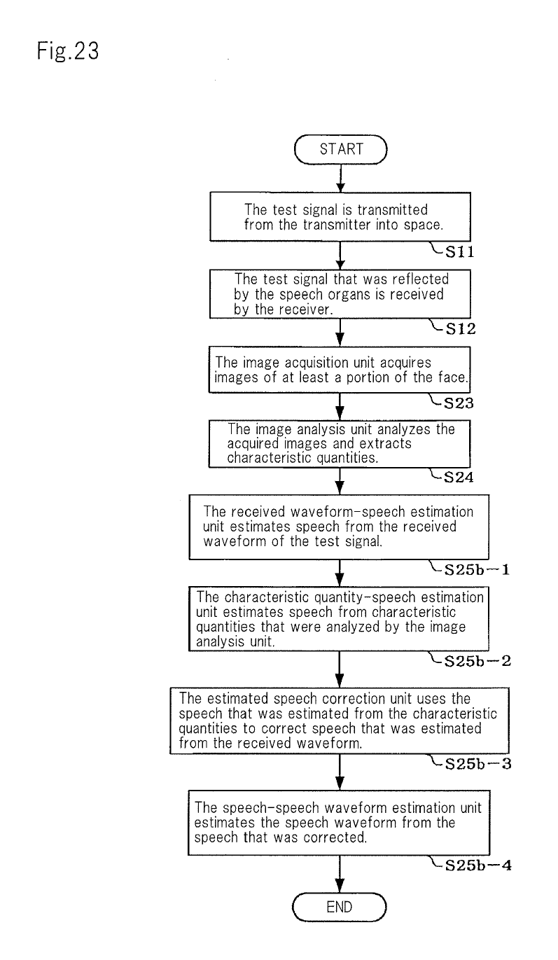

FIG. 23 is a flow chart showing an example of the operation of the speech estimation system that includes speech estimation unit 4 according to the present example. Here, Steps S11, S12, S23, and S24 are the same as operations that have already been explained and explanation is therefore here omitted.

As shown in FIG. 23, the speech estimation system in the present example operates as next described in Step S25 of FIG. 19. Received waveform-speech estimation unit 42b-1 of speech estimation unit 4 first estimates speech from the received waveform of the test signal that was received by receiver 3 (Step S25b-1). Analyzed characteristic quantity-speech estimation unit 42b-2 estimates speech from characteristic quantities that were analyzed by image analysis unit 6 (Step S25b-2).

When speech is estimated by each of received waveform-speech estimation unit 42b-1 and analyzed characteristic quantity-speech estimation unit 42b-2, estimated speech correction unit 42b-3 uses the speech that was estimated by analyzed characteristic quantity-speech estimation unit 42b-2 to correct the speech that was estimated by received waveform-speech estimation unit 42b-1 (Step S25b-3). In other words, estimated speech correction unit 42b-3 corrects the speech that was estimated from a received waveform based on speech that was estimated from characteristic quantities. Speech-speech waveform estimation unit 42b-4 then estimates speech waveforms based on speech that has been corrected by estimated speech correction unit 42b-3 (Step S35b-4).

One example of a method of estimating speech from characteristic quantities that are obtained from images involves using an analyzed characteristic quantity-speech correspondence database that holds the correspondence relations of characteristic quantities obtained from images and speech.

Analyzed characteristic quantity-speech estimation unit 42b-2 includes an analyzed characteristic quantity-speech correspondence database for storing characteristic quantities obtained from images in one-to-one correspondence with speech information. Analyzed characteristic quantity-speech estimation unit 42b-2 compares a characteristic quantity that has been analyzed by image analysis unit 6 with characteristic quantities held in the analyzed characteristic quantity-speech organ shape correspondence database and takes, as the estimated speech, speech that is indicated by speech information that was placed in correspondence with the characteristic quantity that has the highest degree of concurrence with the characteristic quantity.

One method of correcting speech involves computing the weighted mean of speech that was estimated from characteristic quantities and speech that was estimated from a received waveform of the test signal. Estimated speech correction unit 42b-3 carries out a prescribed weighting of values indicating specific elements that are each indicated as the speech that is the estimation result. The speech that is indicated by the speech information that is obtained as a result of finding the weighted mean is then taken as the speech after correction.

Another example of a method for correcting speech involves the use of a corrected speech database that holds the correspondence relations of speech after correction and combinations of speech estimated from characteristic quantities and speech estimated from received waveforms of the test signal.

Estimated speech correction unit 42b-3 includes an estimated speech database for storing combinations of first speech information that indicates speech estimated from characteristic quantities obtained from images and second speech information that indicates speech estimated from received waveforms in correspondence with third speech information that indicates speech after correction. Estimated speech correction unit 42b-3 searches the estimated speech database for the combination of first speech information and second speech information that indicates the combination of speech having the highest degree of concurrence to the combination of speech estimated from characteristic quantities obtained from images and speech estimated from a received waveform. As a result of the search, the speech that is indicated by the third speech information that is placed in correspondence with the combination that was specified is taken as the correction result.

As speech estimation unit 4, an example was described in the present example that carries out estimation as far as a speech waveform, but a speech communication system is also possible in which speech-speech waveform estimation unit 42b-4 is omitted and that supplies as output speech information that indicates speech as the estimation result, as in the first exemplary embodiment.

According to the present example, speech is estimated not only from a received waveform but also from characteristic quantities obtained from images and speech that has been corrected using each of these estimation results is then taken as the estimation result speech, whereby the present example enables estimation of speech with greater reproducibility.

According to the present exemplary embodiment as described hereinabove, characteristics of speech organs that have been analyzed from images can be used to correct speech and speech organ shapes that are estimated from received waveforms, thereby enabling estimation of speech or a speech waveform that is closer to the actual speech. The present example further enables greater reproducibility of characteristics such as the individuality of the speech.

### Third Exemplary Embodiment

The present exemplary embodiment is next described with reference to the accompanying figures.

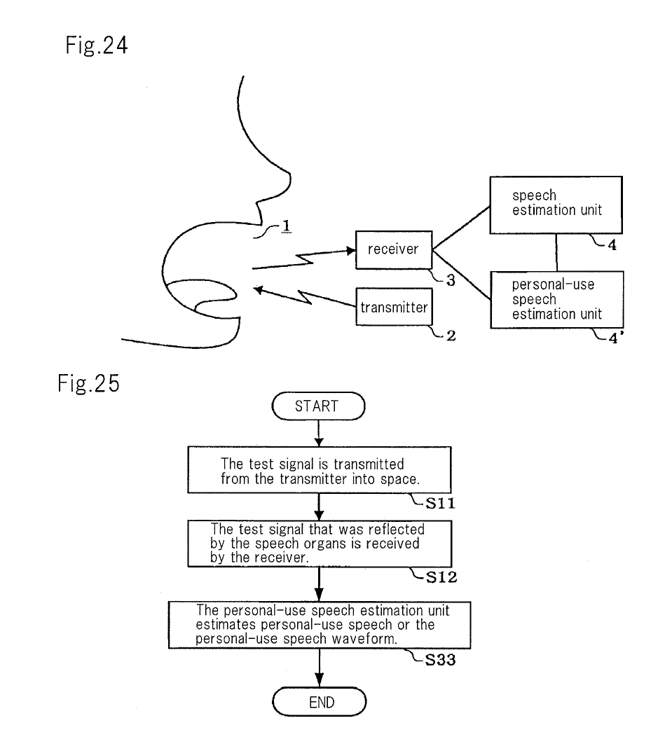

FIG. 24 is a block diagram showing an example of the configuration of the speech estimation system according to the present exemplary embodiment. As shown in FIG. 24, the speech estimation system according to the present exemplary embodiment is of a configuration in which personal-use speech estimation unit 4′ is added to the configuration of the speech estimation system shown in FIG. 1, this personal-use speech estimation unit 4′ being provided for estimating speech for the speaker him or herself, this speech being speech that is to be heard by the speaker.

When uttering speech, the speaker adjusts his or her speech by applying the feedback of hearing the speech that he or she has uttered, and feeding back the estimated speech to the user is therefore important. However, the speech heard by the speaker differs from the speech that is heard by another person. As a result, even if speech estimation unit 4 perfectly reproduces speech, this speech will potentially sound unnatural to the speaker.

The present exemplary embodiment is provided with, in addition to speech estimation unit 4 for estimating speech that is emitted from the person that is the object of estimation, personal-use speech estimation unit 4′ for estimating speech waveforms for the speaker or speech for the speaker, which is the speech at the time that the person that is the target of estimation hears the speech that he or she uttered.

Speech estimation unit 4 can be omitted when only speech for the speaker is estimated. Personal-use speech estimation unit 4′ can be realized by the same basic configuration as speech estimation unit 4 that has already been described. In addition, speech estimation unit 4 and personal-use speech estimation unit 4′ may be realized by the same computer.

The operation of the speech estimation system in the present exemplary embodiment is next described with reference to FIG. 25. FIG. 25 is a flow chart showing an example of the operation of the speech estimation system according to the present exemplary embodiment.

Transmitter 2 first transmits a test signal toward the speech organs (Step S11). Receiver 3 then receives the reflection wave of the test signal that has been reflected at various points of the speech organs (Step S12). The transmission operation and reception operation of the test signal in Steps S11 and S12 are identical to the first exemplary embodiment. Personal-use speech estimation unit 4′ next estimates the personal-use speech or personal-use speech waveform based on the received waveform of the test signal that is received by receiver 3 (Step S33).

At this time, if it is assumed that earphones are provided for allowing the person that is the target of estimation to hear the output of personal-use speech estimation unit 4′, the personal-use speech that was estimated by personal-use speech estimation unit 4′ or the personal-use speech waveform that was estimated by personal-use speech estimation unit 4′ and that has been converted to speech may be supplied by way of the earphones to the person that is the target of estimation.

Because the configuration and actual operation of personal-use speech estimation unit 4′ are basically the same as for speech estimation unit 4, redundant explanation is here omitted. Personal-use speech estimation unit 4′ may estimate a personal-use speech waveform by using a received waveform-personal-use speech waveform correspondence database in which received waveforms are placed in correspondence with personal-use speech waveforms. A personal-use speech waveform may be estimated by making the parameters that are used when subjecting a received waveform to a waveform transform to convert to a speech waveform the parameters for converting to a personal-use speech waveform.

In addition, personal-use speech may be estimated by using a received waveform-personal-use speech correspondence database in which received waveforms are placed in correspondence with personal-use speech. Still further, a personal-use speech waveform may be estimated by using a personal-use speech-personal-use speech waveform correspondence database in which personal-use speech is placed in correspondence with personal-use speech waveforms.

In addition, a personal-use speech waveform may be estimated by using a speech organ shape-personal-use speech waveform correspondence database in which speech organ shapes and personal-use speech waveforms are placed in correspondence. Alternatively, personal-use speech may be estimated by using a speech organ shape-personal-use speech correspondence database in which speech organ shapes and personal-use speech are placed in correspondence. Still further, a personal-use speech waveform may be estimated by deriving a transfer function for finding a personal-use speech waveform based on a received waveform or speech organ shape by using a transfer model up to arrival at the subject's ears.

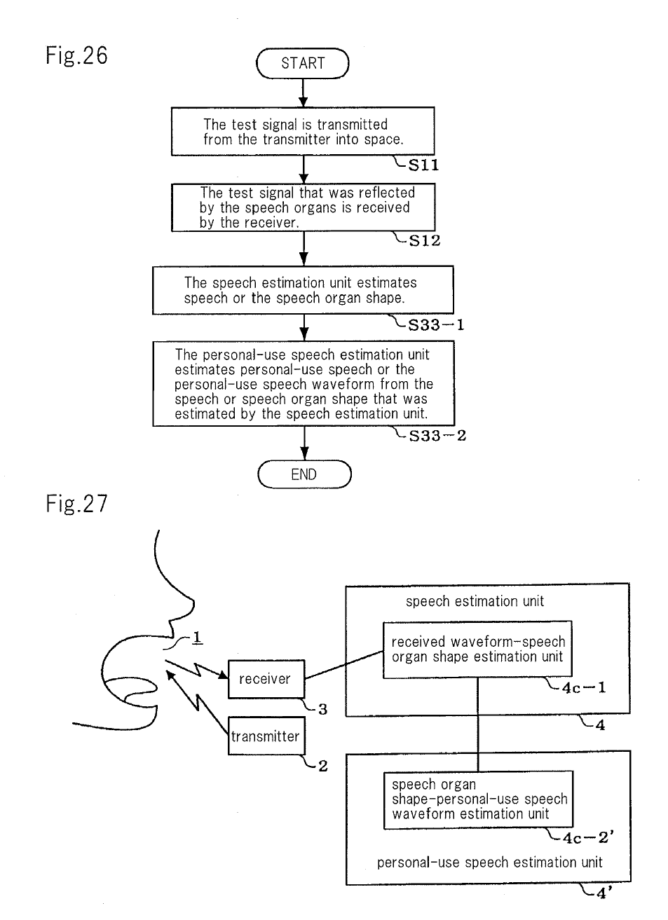

FIG. 26 is a flow chart showing another example of the operation of the speech estimation system according to the present exemplary embodiment.

As shown in FIG. 26, speech estimation unit 4 estimates speech, speech waveforms, or speech organ shapes based on the received waveform of the test signal (Step S33-1). Personal-use speech estimation unit 4′ estimates personal-use speech or a personal-use speech waveform based on the speech, speech waveform, or speech organ shape that has been estimated by speech estimation unit 4 (Step S33-2). In addition, the speech estimation operation, speech waveform estimation operation, and speech organ estimation operation in Step S33-1 are the same as described in the first exemplary embodiment.

The configuration and actual operation of personal-use speech estimation unit 4′ in this case are basically the same as for speech estimation unit 4 with the exception that the information used for estimating personal-use speech or a personal-use speech waveform is for personal use.

Personal-use speech estimation unit 4′ may estimate a personal-use speech waveform by using a speech-personal-use speech waveform correspondence database in which speech estimated by speech estimation unit 4 is placed in correspondence with personal-use speech waveforms. Alternatively, personal-use speech estimation unit 4′ may estimate a personal-use speech waveform by subjecting the speech waveform that was estimated by speech estimation unit 4 to a waveform conversion process for converting to a personal-use speech waveform. Alternatively, personal-use speech estimation unit 4′ may estimate a personal-use speech waveform by using a speech organ shape-personal-use speech waveform correspondence database in which speech organ shapes estimated by speech estimation unit 4 are placed in correspondence with personal-use speech waveforms.

Personal-use speech estimation unit 4′ can also correct a transfer function to derive a personal-use transfer function from speech organ shapes that are estimated by speech estimation unit 4 and then estimate a personal-use speech waveform from this personal-use transfer function. This example is described hereinbelow.

### Example 7

FIG. 27 is a block diagram showing an example of the configuration of speech estimation unit 4 and personal-use speech estimation unit 4′ for a case in which a personal-use transfer function is derived from speech organ shapes estimated by speech estimation unit 4 to estimate a personal-use speech waveform.

As shown in FIG. 27, speech estimation unit 4 includes the received waveform-speech organ shape estimation unit 4c-1 that was described in example 3, and personal-use speech estimation unit 4′ includes speech organ shape-personal-use speech waveform estimation unit 4c-2′. Speech organ shape-personal-use speech waveform estimation unit 4c-2′ carries out a process of estimating a personal-use speech waveform from the shape of speech organs that was estimated by received waveform-speech organ shape estimation function unit 4c-1 of speech estimation unit 4.

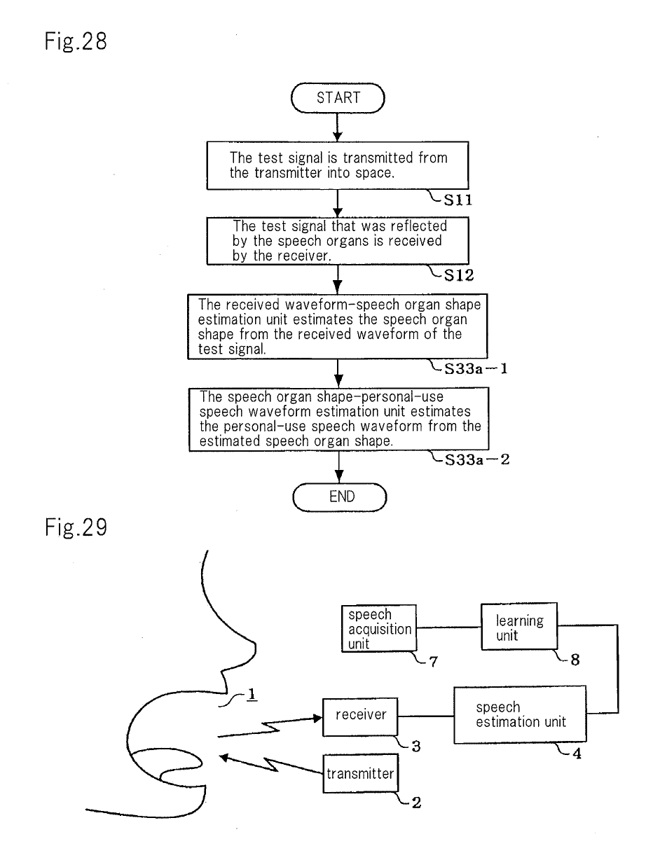

FIG. 28 is a flow chart showing an example of the operation of the speech estimation system that includes speech estimation unit 4 and personal-use speech estimation unit 4′ according to the present example. Here, Steps S11 and S12 are identical to operations that have already been described, and redundant explanation is therefore omitted.

As shown in FIG. 28, in the speech estimation system in the present example, received waveform-speech organ shape estimation unit 4c-1 of speech estimation unit 4 estimates a speech organ shape from a received waveform of the test signal in Step S33-1 shown in FIG. 26 (Step S33a-1). The operation in this step is the same as the operation of Step S13c-1 described in FIG. 12 and detailed explanation is therefore here omitted.

In Step S33-2 shown in FIG. 26, speech organ shape-personal-use speech waveform estimation unit 4c-2′ in personal-use speech estimation unit 4′ next estimates a personal-use speech waveform from the speech organ shape that was estimated by received waveform-speech organ shape estimation function unit 4c-1 (Step S33a-2).

As one example of a method for estimating a personal-use speech waveform from the shape of speech organs, a speech organ shape-transfer function correction information database is used that holds the correspondence relations of speech organ shapes and transfer function correction information.

Speech organ shape-personal-use speech waveform estimation unit 4c-2′ includes a speech organ shape-transfer function correction information database for storing speech organ shape information in one-to-one correspondence with correction information that indicates the correction content of the transfer functions of sound. Speech organ shape-personal-use speech waveform estimation unit 4c-2′ searches the speech organ shape-transfer function correction information database for the speech organ shape information that indicates the shape that has the greatest degree of concurrence to the shape of the speech organs that was estimated by speech estimation unit 4. The transfer function is corrected based on the correction information that is placed in correspondence with the speech organ shape information that was specified as a result of the search. The corrected transfer function is then used to estimate the personal-use speech waveform.

The correction information that is registered in the speech organ shape-transfer function correction information database may be matrix formulas and may be held according to each of the coefficients of the transfer function or according to the parameters that are used in each coefficient.

The transfer function may be derived by received waveform-speech organ shape estimation function unit 4c-1 of speech estimation unit 4. Speech organ shape-personal-use speech waveform estimation unit 4c-2′ of personal-use speech estimation unit 4′, having used the above-described method to derive a transfer function from the shape of speech organs that were estimated, may further correct the transfer function.

According to another approach that may be used, speech organ shape-personal-use speech waveform estimation unit 4c-2′ includes speech organ shape-personal-use speech waveform correspondence database for storing speech organ shape information in correspondence with personal-use speech waveform information. Speech organ shape-personal-use speech waveform estimation unit 4c-2′ searches speech organ shape-personal-use speech waveform correspondence database for speech organ shape information that indicates the shape having the highest degree of concurrence with the shape of speech organs that was estimated by speech estimation unit 4. The speech waveform indicated by the personal-use speech waveform information that was placed in correspondence with the speech organ shape information that was specified as a result of the search is then taken as the estimation result.

According to the present example, the estimation result (in the present example, the transfer function) of speech estimation unit 4 can be used to estimate a personal-use speech waveform, whereby a personal-use speech waveform can be estimated while reducing the processing load compared to estimating from the start.

According to the present exemplary embodiment as described hereinabove, speech that is close to speech that would have been heard when emitted can be made audible to the speaker even when speech is not actually emitted. As a result, the speaker is able to continue a conversation with confidence while adjusting his or her own speech based on this speech that is made audible.

### Fourth Exemplary Embodiment

The present exemplary embodiment is next described with reference to the figures.

FIG. 29 is a block diagram showing an example of the configuration of the speech estimation system according to the present exemplary embodiment. The speech estimation system according to the present exemplary embodiment is realized by adding speech acquisition unit 7 and learning unit 8 to the configuration of the speech estimation system shown in FIG. 1.

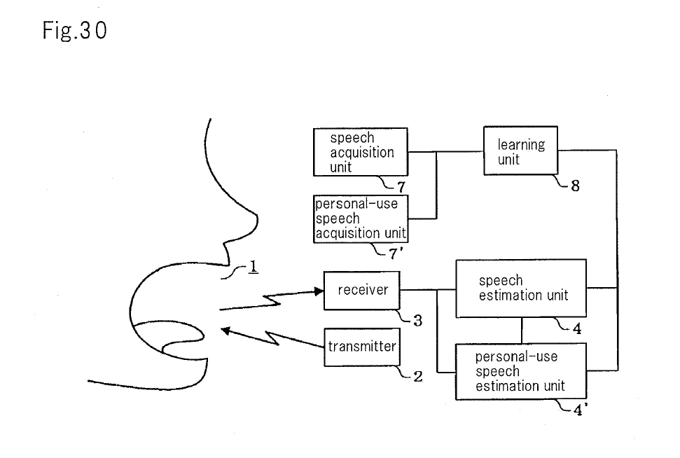

Speech acquisition unit 7 acquires speech that is actually emitted by the person that is the object of estimation. Learning unit 8 learns various types of data that are necessary for estimating speech or a speech waveform that is emitted from the person that is the object of estimate or the various types of data that are necessary for estimating speech or a speech waveform when the person that is the object of estimation is to listen to the speech that he or she utters. When the speech estimation system estimates the personal-use speech or speech waveform, personal-use speech acquisition unit 7′ may be further added to the configuration as shown in FIG. 30.

According to one example, speech acquisition unit 7 is a microphone. Personal-use speech acquisition unit 7′ may also be a microphone, but may also be a bone-conduction microphone shaped as an earphone. Learning unit 8 includes an information processing unit such as a CPU that executes prescribed processes in accordance with a program and a memory device for storing programs.

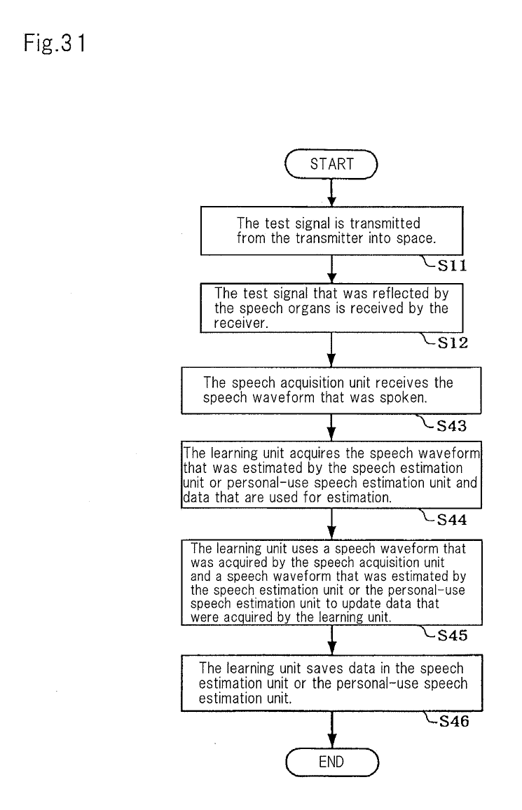

The speech estimation system in the present exemplary embodiment is next described with reference to FIG. 31. FIG. 31 is a flow chart showing an example of the operation of the speech estimation system in the present exemplary embodiment.

In the present exemplary embodiment, transmitter 2 transmits a test signal toward the speech organs even when sound is being emitted (Step S11). Receiver 3 receives the reflected wave of the test signal that is reflected at various points of the speech organs (Step S12). The transmission operation and reception operation of the test signal in Steps S11 and S12 are the same as the first exemplary embodiment, and detailed explanation is therefore here omitted.

Parallel to the reception operation of the test signal, speech acquisition unit 7 acquires the speech that is actually emitted (Step S43). More specifically, speech acquisition unit 7 receives the speech waveform that is the temporal waveform of speech that is actually emitted from the person that is the object of estimation. Together with speech acquisition unit 7, personal-use speech acquisition unit 7′ may also acquire the temporal waveform of speech that is actually audible to the speaker.

When speech acquisition unit 7 or personal-use speech acquisition unit 7′ receives a speech waveform, learning unit 8 acquires the speech waveform that was estimated by speech estimation unit 4 or personal-use speech estimation unit 4′ as well as various types of data that are used for estimating this speech waveform (Step S44). Learning unit 8 uses the speech waveform that was estimated by speech estimation unit 4 or personal-use speech estimation unit 4′ and the actual speech waveform that was acquired by speech acquisition unit 7 to update the various data that are used for estimation (Step S45). The updated data are next fed back to speech estimation unit 4 or personal-use speech estimation unit 4′ (Step S46). Learning unit 8 applies the updated data to speech estimation unit 4 or personal-use speech estimation unit 4′ and causes speech estimation unit 4 or personal-use speech estimation unit 4′ to store the updated data.

The data that learning unit 8 updates are the content of each database held by speech estimation unit 4 or personal-use speech estimation unit 4′ and information of transfer function derivation algorithms.

Five methods will be described as examples of methods for updating data.

The first method involves simply registering the acquired speech waveform in each database without alteration. The second method involves registering information that indicates the relations of the parameters of transfer functions by which an acquired speech waveform is computed. The third method involves saving in the database a speech waveform for which the weighted mean was taken of a speech waveform that was estimated and a speech waveform that was acquired.

The fourth method involves registering information that indicates the relations of the parameters of transfer functions for computing a speech waveform for which the weighted mean is obtained of a speech waveform that was estimated and a speech waveform that was acquired. The fifth method involves finding the difference between a speech waveform that was acquired and a speech waveform that was estimated from a received waveform or the difference between speech that is estimated from a speech waveform that was acquired and speech that was estimated from the received waveform and then registering these differences as correction information for correcting the estimation results.

When learning unit 8 is carrying out learning by registering information that indicates the relations between parameters of transfer functions, speech estimation unit 4 may, when deriving a transfer function, seek parameters that are used in the transfer function based on the relation formulas that are stored in these areas. Alternatively, when learning unit 8 is carrying out learning by registering differences that have been found as correction information, speech estimation unit 4 may add the differences that are indicated as correction information to the results obtained by estimating speech or speech waveforms from received waveforms. The correction information may be information regarding correction that is implemented upon the result of processing that is carried out in the course of estimating speech or speech waveforms.

Explanation next regards actual examples of the learning methods of databases and the derivation algorithms of transfer functions.

(1) Received Waveform-Speech Waveform Correspondence Database

One example of this database learning method involves learning by registering in this database a received waveform that was received by receiver 3 in correspondence with a speech waveform that was acquired by speech acquisition unit 7.

Learning unit 8 saves Rx(t) indicating the change in signal power with respect to time of a received waveform that was received by receiver 3 at the time of sound emission in correspondence with S(t) that indicates the signal power with respect to time of the speech waveform that was acquired by speech acquisition unit 7 at the same time as the received waveform. When Rx(t) is already saved in the database at this time, S(t) should be saved by overwriting as the corresponding speech waveform information. If Rx(t) is not saved, this information and S(t) should be newly added in correspondence with each other.

As another possible method, learning unit 8 saves Rx(f) that indicates signal power with respect to frequency of the received waveform that was received by receiver 3 at the time of sound emission in correspondence with S(f) that indicates signal power with respect to frequency of the speech waveform that was acquired by speech acquisition unit 7 at the same time as the received waveform. When Rx(f) is already saved in the database at this time, S(f) should be saved by overwriting as the corresponding speech waveform information. If Rx(f) is not saved, this information and S(f) should be newly added in correspondence with each other.

Another example of the learning method of this database involves updating by obtaining the weighted mean of a speech waveform that was saved in the database that is searched based on the received waveform that was received by receiver 3 and a speech waveform that was acquired by speech acquisition unit 7.

Learning unit 8 obtains the weighted mean of S(t) of the speech waveform that was acquired by speech acquisition unit 7 and S′(t) of the speech waveform that is registered in the database in correspondence with the received waveform information that indicates the waveform having the highest degree of concurrence with Rx(t) of the received waveform that was received by receiver 3 by means of the following formula: (m·S′(t)+n·S(t)/(m+n)). The obtained value is saved by overwriting in the database. When, as a result of finding the degree of concurrence, a received waveform that surpasses the prescribed degree of concurrence is not registered, learning unit 8 should newly add Rx(t) of the received waveform that was received by receiver 3 in correspondence with S(t) of the speech waveform that was acquired by speech acquisition unit 7 without obtaining the weighted mean.

As another possible method, learning unit 8 obtains the weighted mean of S(f) of a speech waveform that was acquired by speech acquisition unit 7 and S′(f) of a speech waveform that is registered in the database in correspondence with received waveform information that indicates the waveform having the highest degree of concurrence with Rx(f) of the received waveform that was received by receiver 3 according to the following formula: (m·S(f)+n·S′(f)/(m+n)). The obtained value is stored by overwriting in the database. When, as a result of seeking the degree of concurrence, a received waveform that surpasses the prescribed degree of concurrence is not registered, learning unit 8 should newly add Rx(f) of the received waveform that was received by receiver 3 in correspondence with S(f) of the speech waveform that was acquired by speech acquisition unit 7 without obtaining the weighted mean.

(2) Received Waveform-Speech Correspondence Database

An example of the database learning method involves learning by registering in the database the received waveform that was received by receiver 3 in correspondence with speech estimated from the speech waveform that was acquired by speech acquisition unit 7.

Learning unit 8 saves Rx(t) of the received waveform that was received by receiver 3 at the time of sound emission in the database in correspondence with speech that is estimated from S(t) of the speech waveform that was acquired by speech acquisition unit 7 at the same time as the received waveform. When Rx(t) is already saved in the database at this time, speech information that indicates speech that is estimated from S(t) should be saved by overwriting as the corresponding speech information. If Rx(t) has not been saved, the received waveform information and speech information that is estimated from S(t) should be newly added in correspondence with each other.

Alternatively, as another possible method, learning unit 8 saves in the database Rx(f) of the received waveform that was received by receiver 3 at the time of sound emission in correspondence with speech that is estimated from S(f) of the speech waveform that was acquired by speech acquisition unit 7 at the same time as the received waveform. If Rx(f) is already saved in the database at this time, speech information that indicates speech that is estimated from S(f) should be saved by overwriting as the corresponding speech information. If Rx(f) is not saved, the received waveform information and speech information that is estimated from S(f) should be newly added in correspondence with each other.

A DP (Dynamic Programming) matching method, an HMM (Hidden Markov Model) method, or a method such as searching the speech-speech waveform correspondence database can here be used as the method of estimating speech from S(t) or S(f) of a speech waveform.

(3) Speech-Speech Waveform Correspondence Database

One example of a database learning method involves learning by registering in the database speech that is estimated from the received waveform that was received by receiver 3 in correspondence with the speech waveform that was acquired by speech acquisition unit 7.

Learning unit 8 saves in the database speech that is estimated by speech estimation unit 4 from the received waveform that was received by receiver 3 at the time of sound emission in correspondence with S(t) or S(f) of the speech waveform that was acquired by speech acquisition unit 7 at the same time as the received waveform. If speech that is estimated from the received waveform is already saved in the database at this time, S(t) or S(f) should be saved by overwriting as the corresponding speech waveform information. If estimated speech has not been saved, this information and S(t) or S(f) should be newly added in correspondence with each other.

Another example of the database learning method involves updating by obtaining the weighted mean of a speech waveform that is saved in the database that is searched based on speech that has been estimated and the speech waveform that was acquired by speech acquisition unit 7.

Learning unit 8 takes the m:n weighted mean of S(t) of the speech waveform that was acquired by speech acquisition unit 7 and Sd(t) of the speech waveform registered in the database in correspondence with speech information that indicates the speech having the highest degree of concurrence with the speech that was estimated from the received waveform that was received by receiver 3 by means of the following formula: (m·S(t)+n·Sd(t)/(m+n)). The obtained value is saved by overwriting in the database. If, as a result of finding the degree of concurrence, speech that surpasses the prescribed degree of concurrence is not registered, learning unit 8 should newly add speech that was estimated from Rx(t) of that received waveform that was received by receiver 3 and S(t) of the speech waveform that was acquired by speech acquisition unit 7 in correspondence with each other without obtaining the weighted mean.

According to another possible method, learning unit 8 obtains the m:n weighted mean of S(f) of the speech waveform that was acquired by speech acquisition unit 7 and Sd(f of the speech waveform that is registered in the database in correspondence with speech information that indicates the speech having the highest degree of concurrence with speech that is estimated from the received waveform that was received by receiver 3 according to the following formula: (m·S(f)+n·Sd(f)/(m+n)). The obtained value is saved by overwriting in the database. If, as a result of seeking the degree of concurrence, speech that surpasses the prescribed degree of concurrence is not registered, learning unit 8 should newly add speech that was estimated from Rx(f) of the received waveform that was received by receiver 3 and S(f) of the speech waveform that was acquired by speech acquisition unit 7 in correspondence with each other without obtaining the weighted mean.

(4) Analyzed Characteristic Quantity-Speech Correspondence Database

According to one example of the database learning method, learning is realized by registering in the database a characteristic quantity that was analyzed by image analysis unit 6 in correspondence with speech that is estimated from the speech waveform that was acquired by speech acquisition unit 7.

Learning unit 8 saves in the database a characteristic quantity that was analyzed by image analysis unit 6 from images acquired by image acquisition unit 5 at the time of sound emission in correspondence with speech that is estimated from S(t) or S(f) of the speech waveform that was acquired by speech acquisition unit 7 at the same time as the images. If a characteristic quantity that was analyzed by image analysis unit 6 is already stored in the database, speech that is estimated from S(t) or S(f) should be saved by overwriting as the corresponding speech information. If a characteristic quantity has not been saved, this information and speech that is estimated from S(t) or S(f) should be newly added in correspondence with each other. A method that has already been described may be used as the method of estimating speech from speech waveforms.

(5) Estimated Speech Database

According to one example of the database learning method, learning is realized by registering in the database a combination of speech that is estimated from the received waveform that was received by receiver 3 and speech that is estimated from characteristic quantities analyzed by image analysis unit 6 in correspondence with speech that is estimated from the speech waveform that was acquired by speech acquisition unit 7. A method that has already been described may be used as the method of estimating speech from speech waveforms.

(6) Received Waveform-Speech Organ Shape Correspondence Database

According to one example of the database learning method, learning is realized by registering the received waveform that was received by receiver 3 in the database in correspondence with a speech organ shape that is estimated from the speech waveform that was acquired by speech acquisition unit 7.

Learning unit 8 saves in the database Rx(t) of the received waveform that was received by receiver 3 at the time of sound emission in correspondence with a speech organ shape that is estimated from S(t) of the speech waveform that was acquired by speech acquisition unit 7 at the same time as the received waveform. Here, a method such as inferring based on a Kelly speech generation model and searching the speech organ shape-speech waveform correspondence database can be used as the method of estimating a speech organ shape from S(t) of a speech waveform.

According to another possible method, learning unit 8 saves Rx(f) of the received waveform that was received by receiver 3 at the time of sound emission in the database in correspondence with a speech organ shape that is estimated from S(f) of the speech waveform that was acquired by speech acquisition unit 7 at the same time as the received waveform. Here, a method such as inferring from a Kelly speech generation model and searching the speech organ shape-speech waveform correspondence database can be used as the estimating a speech organ shape from S(f) of a speech waveform.

(7) Speech Organ Shape-Speech Waveform Correspondence Database

As an example of the database learning method, learning is realized by registering a speech organ shape that is estimated from the received waveform that was received by receiver 3 in the database in correspondence with the speech waveform acquired by speech acquisition unit 7.

Learning unit 8 saves a speech organ shape that is estimated from Rx(t) of the received waveform that was received by receiver 3 at the time of sound emission in the database in correspondence with S(t) of the speech waveform that was acquired by speech acquisition unit 7 at the same time as the received waveform. When a speech organ shape that was estimated from the received waveform is already saved in the database at this time, S(t) should be saved by overwriting as the corresponding speech waveform information. If speech organ shape information has not been saved, this information and S(t) should be newly added in correspondence with each other.

According to another possible method, learning unit 8 saves a speech organ shape that is estimated from Rx(f) of the received waveform that was received by receiver 3 at the time of sound emission in the database in correspondence with S(f) of the speech waveform that was acquired by speech acquisition unit 7 at the same time as the received waveform. When a speech organ shape that was estimated from the received waveform is already saved in the database at this time, S(f) should be saved by overwriting as the corresponding speech waveform information. If a speech organ shape is not already saved, this information and S(f) should be newly added in correspondence with each other.

According to another database learning method, updating is realized by taking the weighted mean of speech waveforms that were saved in the database that is searched based on the speech organ shape that is estimated from the received waveform that was received by receiver 3 and the speech waveform that was acquired by speech acquisition unit 7.

Learning unit 8 obtains the m:n weighted mean of S(t) of the speech waveform that was acquired by speech acquisition unit 7 and Sd(t) of a speech waveform that is registered in the database in correspondence with speech organ shape information that indicates the shape having the highest degree of concurrence with the speech organ shape that is estimated from the received waveform that was received by receiver 3 according to the following formula: (m·S(t)+n·Sd(t)/(m+n)). The obtained value is saved by overwriting in the database. If, as a result of seeking degrees of concurrence, a speech organ shape that surpasses the prescribed degree of concurrence is not registered, the speech organ shape that is estimated from the received waveform that was received at receiver 3 and S(t) of the speech waveform that was acquired by speech acquisition unit 7 should be newly added in correspondence with each other without taking the weighted mean.

According to another possible method, learning unit 8 obtains the m:n weighted mean of S(f) of the speech waveform that was acquired by speech acquisition unit 7 and Sd(f) of the speech waveform registered in the database in correspondence with the speech organ shape information that indicates the shape having the highest degree of concurrence with the speech organ shape that is estimated from the received waveform that was received by receiver 3 according to the following formula: (m·S(f)+n·Sd(f)/(m+n)). The obtained value is saved by overwriting in the database. If, as a result of seeking degrees of concurrence, a speech organ shape that surpasses the prescribed degree of concurrence is not registered, the speech organ shape estimated from the received waveform that was received at receiver 3 and S(f) of the speech waveform that was acquired by speech acquisition unit 7 should be newly added in correspondence with each other without finding the weighted mean.

(8) Analyzed Characteristic Quantity-Speech Organ Shape Correspondence Database

According to one example of the database learning method, learning is realized by registering a characteristic quantity analyzed by image analysis unit 6 in the database in correspondence with a speech organ shape estimated from the speech waveform that was acquired by speech acquisition unit 7.

Learning unit 8 saves in the database a characteristic quantity analyzed by image analysis unit 6 from images that were acquired by image acquisition unit 5 at the time of sound emission in correspondence with a speech organ shape estimated from S(t) or S(f) of the speech waveform that was acquired by speech acquisition unit 7 at the same time as the images. If a characteristic quantity analyzed by image analysis unit 6 is already saved in the database at this time, speech organ shape information indicating the speech organ shape estimated from S(t) or S(f) should be saved by overwriting as the corresponding speech organ information. If a characteristic quantity is not saved, this information and speech organ shape information indicating the speech organ shape estimated from S(t) or S(f) should be newly added in correspondence with each other.

A method that has already been described may be used as the method of estimating a speech organ shape from a speech waveform.

(9) Estimated Speech Organ Shape Database

According to one example of a database learning method, learning is realized by registering in the database a combination of a speech organ shape estimated from the received waveform that was received by receiver 3 and a speech organ shape estimated from a characteristic quantity that was analyzed by image analysis unit 6 in correspondence with a speech organ shape that is estimated from the speech waveform that was acquired by speech acquisition unit 7.

Learning unit 8 saves in the database a combination of a speech organ shape that is estimated from a received waveform that was received by receiver 3 at the time of sound emission and a speech organ shape estimated from a characteristic quantity that was analyzed by image analysis unit 6 from images that were acquired by image acquisition unit 5 at the same time in correspondence with a speech organ shape that is estimated from S(t) or S(f) of the speech waveform that was acquired by speech acquisition unit 7 at the same time.

A method that has already been described may be used as the method of estimating the speech organ shape from speech waveforms.

(10) Speech Organ Shape-Speech Correspondence Database

According to one example of the database learning method, learning is realized by registering in the database a speech organ shape estimated from the received waveform that was received by receiver 3 in correspondence with speech that is estimated from the speech waveform that was acquired by speech acquisition unit 7.

Learning unit 8 saves in the database a speech organ shape estimated from Rx(t) of the received waveform that was received by receiver 3 at the time of sound emission in correspondence with speech that is estimated from S(t) of the speech waveform that was acquired by speech acquisition unit 7 at the same time as the received waveform.

According to another possible method, learning unit 8 saves in the database a speech organ shape that is estimated from Rx(f) of the received waveform that was received by receiver 3 at the time of sound emission in correspondence with speech that is estimated from S(f) of the speech waveform that was acquired by speech acquisition unit 7 at the same time as the received waveform.

A method that has already been described may be used as the method of estimating speech from a speech waveform.

(11) Received Waveform-Personal-Use Speech Waveform Correspondence Database

According to one example of this database learning method, learning is realized by registering in the database a received waveform that was received by receiver 3 in correspondence with a personal-use speech waveform that is estimated from the speech waveform that was acquired by personal-use speech acquisition unit 7.

Learning unit 8 saves Rx(t) of the received waveform received by receiver 3 at the time of sound emission in correspondence with S′(t) of a personal-use speech waveform that is estimated from S(t) of the speech waveform that was acquired by speech acquisition unit 7 at the same time. When Rx(t) is already saved in the database at this time, S′(t) should be saved by overwriting as the corresponding personal-use speech waveform information. If Rx(t) is not saved, this information and S′(t) should be newly added in correspondence with each other. As the method for estimating S′(t) of a personal-use speech waveform from S(t) of a speech waveform, a method can be used in which S(t) of the speech waveform is subjected to a waveform conversion process to convert to S′(t) of the personal-use speech waveform.

Learning unit 8 saves Rx(f) of the received waveform that was received by receiver 3 at the time of sound emission in correspondence with S′(f) of a personal-use speech waveform that is estimated from S(f) of the speech waveform that was acquired by speech acquisition unit 7 at the same time. When Rx(f) is already saved in the database at this time, S′(f) should be saved by overwriting as the corresponding personal-use speech waveform information. If Rx(f) is not saved, this information and S′(f) should be newly added in correspondence with each other. As the method for estimating S′(f) of a personal-use speech waveform from S(f) of a speech waveform, a method should be used for subjecting S(f) of the speech waveform to a waveform conversion process to convert to S′(f) of the personal-use speech waveform.

According to another example of the database learning method, the weighted mean of a personal-use speech waveform that has been saved in the database that is searched from the received waveform that was received by receiver 3 and a personal-use speech waveform that is estimated from the speech waveform that was acquired by speech acquisition unit 7 is obtained to implement updating.

Learning unit 8 obtains the m:n weighted mean of S′(t) of a personal-use speech waveform that is estimated from S(t) of the speech waveform that was acquired by speech acquisition unit 7 and Sd′(t) of a personal-use speech waveform registered in the database in correspondence with the received waveform information that indicates the waveform having the highest degree of concurrence with the received waveform that was received by receiver 3 according to the following formula: (m·S′(t)+n·Sd′(t)/(m+n)). The obtained value is saved by overwriting in the database. If, as the result of seeking degrees of concurrence, a received waveform that surpasses the prescribed degree of concurrence is not registered, the received waveform received by receiver 3 and S′(t) of the personal-use speech waveform that is estimated from S(t) of the speech waveform that was acquired by speech acquisition unit 7 should be newly added in correspondence with each other without obtaining the weighted mean.

As another possible method, learning unit 8 finds the m:n weighted mean of S′(f) of a personal-use speech waveform that is estimated from S(f) of the speech waveform that was acquired by speech acquisition unit 7 and Sd′(f) of the personal-use speech waveform that is registered in the database in correspondence with received waveform information that indicates the waveform having the highest degree of concurrence with the received waveform that was received by receiver 3 according to the following formula: (m·S′(f)+n·Sd′(f)/(m+n)). The obtained value is saved by overwriting in the database. If, as a result of seeking degrees of concurrence, a received waveform that surpasses the prescribed degree of concurrence is not registered, the received waveform that was received by receiver 3 and S′(f) of the personal-use speech waveform that is estimated from S(f) of the speech waveform that was acquired by speech acquisition unit 7 should be newly added in correspondence with each other without obtaining the weighted mean.

As another example of the database learning method, learning is realized by registering the received waveform that was received by receiver 3 in the database in correspondence with the personal-use speech waveform that was acquired by personal-use speech acquisition unit 7′.

Learning unit 8 saves Rx(t) of the received waveform that was received by receiver 3 at the time of sound emission in correspondence with S′(t) of the personal-use speech waveform that was acquired by personal-use speech acquisition unit 7′ at the same time. When Rx(t) is already saved in the database at this time, S′(t) should be saved by overwriting as the corresponding personal-use speech waveform information. If Rx(t) is not saved, this information and S′(t) should be newly added in correspondence with each other.

Alternatively, according to another possible method, learning unit 8 saves Rx(f) of the received waveform that was received by receiver 3 at the time of sound emission in correspondence with S′(f″) of the personal-use speech waveform that was acquired by personal-use speech acquisition unit 7′ at the same time. When Rx(f) is already saved in the database at this time, S′(f) should be saved by overwriting as the corresponding personal-use speech waveform information. If Rx(f) is not saved, this information and S′(f) should be newly added in correspondence with each other.

According to another example of the database learning method, updating is realized by obtaining the weighted mean of a personal-use speech waveform that has been saved in the database that is searched from the received waveform that was received by receiver 3 and the personal-use speech waveform that was acquired by personal-use speech acquisition unit 7′.

Learning unit 8 obtains the m:n weighted mean of S′(t) of a personal-use speech waveform that was acquired by personal-use speech acquisition unit 7′ and Sd′(t) of a personal-use speech waveform that is registered in the database in correspondence with the received waveform information that indicates the waveform having the highest degree of concurrence with the received waveform that was received by receiver 3 according to the following formula: (m·S′(t)+n·Sd′(t)/(m+n)). The obtained value is saved by overwriting in the database. If, as a result of seeking degrees of concurrence, a received waveform that surpasses the prescribed degree of concurrence is not registered, the received waveform that was received at receiver 3 and S′(t) of the personal-use speech waveform that was acquired by personal-use speech acquisition unit 7′ should be newly added in correspondence with each other without taking the weighted mean.

According to another possible method, learning unit 8 obtains the m:n weighted mean of S′(f) of the personal-use speech waveform that was acquired by personal-use speech acquisition unit 7′ and Sd′(f) of a personal-use speech waveform that is registered in the database in correspondence with the received waveform information that indicates the waveform having the highest degree of concurrence with the received waveform that was received by receiver 3 according to the following formula: (m-S′(f)+n·Sd′(f)/(m+n)). The obtained value is saved by overwriting in the database. When as a result of seeking degrees of concurrence, a received waveform that surpasses the prescribed concurrence is not registered, the received waveform that was received by receiver 3 and S′(f) of the personal-use speech waveform that was acquired by personal-use speech acquisition unit 7′ should be newly added in correspondence with each other without obtaining the weighted mean.

(12) Received Waveform-Personal Speech Correspondence Database

According to one example of a database learning method, learning is realized by registering the received waveform that was received by receiver 3 in the database in correspondence with the personal-use speech that is estimated from the speech waveform that was acquired by speech acquisition unit 7.

Learning unit 8 saves Rx(t) of the received waveform that was received by receiver 3 at the time of sound emission in correspondence with personal-use speech that is estimated from S(t) of the speech waveform that was acquired by speech acquisition unit 7 at the same time. When Rx(t) is already saved in the database at this time, personal-use speech that is estimated from S(t) should be saved by overwriting as the corresponding personal-use speech information. If Rx(t) is not saved, this information and personal-use speech that is estimated from S(t) should be newly added in correspondence with each other.

According to another possible method, learning unit 8 saves Rx(f) of the received waveform that was received by receiver 3 at the time of sound emission in correspondence with personal-use speech that is estimated from S(f) of the speech waveform that was acquired by speech acquisition unit 7 at the same time. When Rx(f) is already saved in the database at this time, personal-use speech that is estimated from S(f) should be saved by overwriting as the corresponding personal-use speech information. If Rx(f) is not saved, this information and personal-use speech estimated from S(f) should be newly added in correspondence with each other.

An example of the method for estimating personal-use speech from a speech waveform is next presented. There is a method of estimating personal-use speech after estimating speech from S(t) or S(f) of a speech waveform, and there is a method of estimating personal-use speech after estimating S′(t) of a personal-use speech waveform from S(t) of a speech waveform. There is also a method of estimating personal-use speech after estimating S′(f) of a personal-use speech waveform from S(f) of a speech waveform. At this time, a method of altering various parameters such as tone, sound volume, and speech quality may be used as a method of estimating personal-use speech from speech.

According to another database learning method, learning is realized by registering the received waveform that was received by receiver 3 in the database in correspondence with personal-use speech that is estimated from the personal-use speech waveform that was acquired by personal-use speech acquisition unit 7′.

Learning unit 8 saves Rx(t) of the received waveform that was received by receiver 3 at the time of sound emission in correspondence with personal-use speech that is estimated from S′(t) of the personal-use speech waveform that was acquired by personal-use speech acquisition unit 7′ at the same time. When Rx(t) is already saved in the database at this time, personal-use speech that is estimated from S′(t) should be saved by overwriting as the corresponding personal-use speech waveforms. If Rx(t) is not saved, this information and personal-use speech that is estimated from S′(t) should be newly added in correspondence with each other.

According to another possible method, learning unit 8 saves Rx(f) of the received waveform that was received by receiver 3 at the time of sound emission in correspondence with personal-use speech that is estimated from S′(f) of the personal-use speech waveform that was acquired by personal-use speech acquisition unit 7′ at the same time. When Rx(f) is already saved in the database at this time, personal-use speech estimated from S′(f) should be saved by overwriting as the corresponding personal-use speech waveforms. If Rx(f) is not saved, this information and personal-use speech estimated from S′(f) should be newly added in correspondence with each other.

(13) Personal-Use Speech-Personal-Use Speech Waveform Correspondence Database

According to one example of a database learning method, learning is realized by registering personal-use speech that is estimated from the received waveform that was received by receiver 3 in the database in correspondence with a personal-use speech waveform that is estimated from the speech waveform that was acquired by speech acquisition unit 7.

When personal-use speech that is estimated from Rx(t) of the received waveform that was received by receiver 3 is already saved in the database at this time, S′(t) of the personal-use speech waveform that is estimated from S(t) of a speech waveform should be saved by overwriting as the corresponding personal-use speech waveform information. If Rx(t) is not saved, this information and S′(t) of the personal-use speech waveform that is estimated from S(t) should be newly added in correspondence with each other.

When personal-use speech that is estimated from Rx(f) of the received waveform that was received by receiver 3 is already saved in the database, S′(f) of the personal-use speech waveform that is estimated from S(f) of a speech waveform should be saved by overwriting as the corresponding personal-use speech waveform information. If Rx(f) is not saved, this information and S′(f) of the personal-use speech waveform that is estimated from S(f) should be newly added in correspondence with each other.

According to another example of the database learning method, updating is implemented by obtaining the weighted mean of a personal-use speech waveform that was saved in the database that is searched from personal-use speech that is estimated from the received waveform that was received by receiver 3 and the personal-use speech waveform that is estimated from the speech waveform that was acquired by speech acquisition unit 7.

Learning unit 8 obtains the m:n weighted mean of S′(t) of a personal-use speech waveform that is estimated from S(t) of the speech waveform that was acquired by speech acquisition unit 7 and Sd′(t) of a personal-use speech waveform that is registered in the database in correspondence with the personal-use speech information that indicates the speech having the highest degree of concurrence with the personal-use speech that is estimated from the received waveform that was received by receiver 3 according to the following formula: (m·S′(t)+n·Sd′(t)/(m+n)). The obtained value is saved by overwriting in the database.

When, as a result of seeking degrees of concurrence, personal-use speech that surpasses the prescribed degree of concurrence is not registered, personal-use speech that is estimated from the received waveform that was received by receiver 3 and S′(t) of a personal-use speech waveform that is estimated from S(t) of the speech waveform that was acquired by speech acquisition unit 7 should be newly added in correspondence with each other without obtaining the weighted mean.

According to another possible method, learning unit 8 obtains the m:n weighted mean of S′(f) of a personal-use speech waveform that is estimated from S(f) of the speech waveform that was acquired by speech acquisition unit 7 and Sd′(f) of a personal-use speech waveform that is registered in the database in correspondence with the personal-use speech information that indicates speech having the highest degree of concurrence with the personal-use speech that is estimated from the received waveform that was received by receiver 3 according to the following formula: (m·S′(f)+n·Sd′(f)/(m+n)). The obtained value is saved by overwriting in the database.

If, as a result of seeking degrees of concurrence, personal-use speech that surpasses the prescribed degree of concurrence is not registered, personal-use speech that is estimated from the received waveform that was received by receiver 3 and S′(f) of a personal-use speech waveform that is estimated from S(f) of the speech waveform that was acquired by speech acquisition unit 7 should be newly added in correspondence with each other without obtaining the weighted mean.

According to another example of a database learning method, learning is realized by registering personal-use speech that is estimated from the received waveform that was received by receiver 3 in the database in correspondence with the personal-use speech waveform that was acquired by personal-use speech acquisition unit 7′.

Learning unit 8 saves personal-use speech that is estimated from Rx(t) of the received waveform that was received by receiver 3 at the time of sound emission in correspondence with S′(t) of the personal-use speech waveform that was acquired by personal-use speech acquisition unit 7′ at the same time. When personal-use speech estimated from Rx(t) is already saved in the database at this time, S′(t) should be saved by overwriting as the corresponding personal-use speech waveform information. When personal-use speech estimated from Rx(t) is not saved, this information and S′(t) should be newly added in correspondence with each other.

Learning unit 8 saves personal-use speech that is estimated from Rx(f) of the received waveform that was received by receiver 3 at the time of sound emission in correspondence with S′(f) of the personal-use speech waveform that was acquired by personal-use speech acquisition unit 7′ at the same time. If personal-use speech estimated from Rx(f) is already saved in the database at this time, S′(f) should be saved by overwriting as the corresponding personal-use speech waveform information. If personal-use speech estimated from Rx(f) is not saved, this information and S′(f) should be newly added in correspondence with each other.

According to another example of the database learning method, updating is realized by obtaining the weighted mean of a personal-use speech waveform that is saved in the database that is searched from personal-use speech that is estimated from the received waveform that was received by receiver 3 and the personal-use speech waveform that was acquired by personal-use speech acquisition unit 7′.

Learning unit 8 obtains the m:n weighted mean of S′(t) of the personal-use speech waveform that was acquired by personal-use speech acquisition unit 7′ and Sd′(t) of a personal-use speech waveform that is registered in the database in correspondence with the speech information that indicates speech having the highest degree of concurrence with personal-use speech that is estimated from the received waveform that was received by receiver 3 according to the following formula: (m·S′(t)+n·Sd′(t)/(m+n)). The obtained value is saved by overwriting in the database.

If, as a result of seeking degrees of concurrence, speech that surpasses the prescribed degree of concurrence is not registered, personal-use speech that is estimated from the received waveform that was received by receiver 3 and S′(t) of the personal-use speech waveform that was acquired by personal-use speech acquisition unit 7′ should be newly added in correspondence with each other without obtaining the weighted mean.

Learning unit 8 obtains the m:n weighted mean of S′(f) of the personal-use speech waveform that was acquired by personal-use speech acquisition unit 7′ and Sd′(f) of a personal-use speech waveform that is registered in the database in correspondence with the speech information that indicates the speech having the highest degree of concurrence with personal-use speech that is estimated from the received waveform that was received by receiver 3 according to the following formula: (m·S′(f)+n·Sd′(f)/(m+n)). The obtained value is saved by overwriting in the database.

If, as a result of seeking degrees of concurrence, speech that surpasses the prescribed degree of concurrence is not registered, personal-use speech that is estimated from the received waveform that was received by receiver 3 and S′(f) of the personal-use speech waveform that was acquired by personal-use speech acquisition unit 7′ should be newly added in correspondence with each other without obtaining the weighted mean.

(14) Analyzed Characteristic Quantity-Personal-Use Speech Correspondence Database

According to an example of this database learning method, learning is realized by registering a characteristic quantity that was analyzed by image analysis unit 6 in the database in correspondence with personal-use speech that is estimated from the speech waveform that was acquired by speech acquisition unit 7.

Learning unit 8 saves a characteristic quantity that was analyzed by image analysis unit 6 from images that were acquired by image acquisition unit 5 at the time of sound emission in the database in correspondence with personal-use speech that is estimated from S(t) or S(f) of the speech waveform that was acquired by speech acquisition unit 7 at the same time as the images.

According to another example of this database learning method, learning is realized by registering a characteristic quantity that was analyzed by image analysis unit 6 in the database in correspondence with personal-use speech that is estimated from the personal-use speech waveform that was acquired by personal-use speech acquisition unit 7′.

Learning unit 8 saves in the database a characteristic quantity that was analyzed by image analysis unit 6 from images acquired by image acquisition unit 5 at the time of sound emission in correspondence with personal-use speech that is estimated from S′(t) or S′(f) of the personal-use speech waveform that was acquired by personal-use speech acquisition unit 7′ at the same time as the images.

(15) Estimated Personal-Use Speech Database

According to an example of this database learning method, learning is realized by registering a combination of personal-use speech that is estimated from the received waveform that was received by receiver 3 and personal-use speech that is estimated from a characteristic quantity that was analyzed by image analysis unit 6 in the database in correspondence with personal-use speech that is estimated from the speech waveform that was acquired by speech acquisition unit 7.

(16) Speech Organ Shape-Transfer Function Correction Information Database

According to an example of this database learning method, learning is realized by carrying out the following three processes. The first is a process of estimating a first transfer function from a speech organ shape that is estimated from the received waveform that was received by receiver 3 and the speech waveform that was acquired by speech acquisition unit 7. The second is a process of estimating a second transfer function from the speech organ shape that is estimated from the received waveform that was received by receiver 3 and the personal-use speech waveform that was acquired by personal-use speech acquisition unit 7′. The third is a process of registering the difference between the first transfer function and the second transfer function in the database in correspondence with the speech organ shapes that are estimated from the received waveforms.

(17) Speech Organ Shape—Personal-Use Speech Waveform Correspondence Database

According to one example of this database learning method, learning is realized by registering a speech organ shape that is estimated from the received waveform that was received by receiver 3 in the database in correspondence with a personal-use speech waveform that is estimated from the speech waveform that was acquired by speech acquisition unit 7.

Learning unit 8 saves a speech organ shape that is estimated from Rx(t) of the received waveform that was received by receiver 3 at the time of sound emission in the database in correspondence with S′(t) of a personal-use speech waveform that is estimated from S(t) of the speech waveform that was acquired by speech acquisition unit 7 at the same time as the received waveform. If a speech organ shape that was estimated from the received waveform is already saved in the database at this time, S′(t) should be saved by overwriting as the corresponding personal-use speech waveform information. If a speech organ shape is not saved, this information and S′(t) should be newly added in correspondence with each other.

According to another possible method, learning unit 8 saves a speech organ shape that is estimated from Rx(f) of the received waveform that was received by receiver 3 at the time of sound emission in the database in correspondence with S′(f) of a personal-use speech waveform that is estimated from S(f) of the speech waveform that was acquired by speech acquisition unit 7 at the same time as the received waveforms. If a speech organ shape that was estimated from the received waveform is already saved in the database at this time, S′(f) should be saved by overwriting as the corresponding personal-use speech waveform information. If a speech organ shape is not saved, this information and S′(f) should be newly added in correspondence with each other.

As another example of this database learning method, updating is realized by obtaining the weighted mean of a personal-use speech waveform that is saved in the database that is searched from a speech organ shape that is estimated from the received waveform that was received by receiver 3 and a personal-use speech waveform that is estimated from the speech waveform that was acquired by speech acquisition unit 7.

Learning unit 8 obtains the m:n weighted mean of S′(t) of the personal-use speech waveform that is estimated from S(t) of the speech waveform that was acquired by speech acquisition unit 7 and Sd′(t) of a personal-use speech waveform that is registered in the database in correspondence with the speech organ shape information that indicates the shape having the highest degree of concurrence with the speech organ shape that is estimated from the received waveform that was received by receiver 3 according to the following formula: (m·S′(t)+n·Sd′(t)/(m+n)). The obtained value is saved by overwriting in the database.

If, as a result of finding degrees of concurrence, a speech organ shape that surpasses the prescribed degree of concurrence is not registered, the speech organ shape that is estimated from the received waveform that was received by receiver 3 and S′(t) of the personal-use speech waveform that is estimated from S(t) of the speech waveform that was acquired by speech acquisition unit 7 should be newly added in correspondence with each other without obtaining the weighted mean.

According to another possible method, learning unit 8 obtains the m:n weighted mean of S′(f) of a personal-use speech waveform that is estimated from S(f) of the speech waveform that was acquired by speech acquisition unit 7 and Sd′(f) of a personal-use speech waveform that is registered in the database in correspondence with the speech organ shape information that indicates the shape having the highest degree of concurrence with the speech organ shape that is estimated from the received waveform that was received by receiver 3 according to the following formula: (m·S′(f)+n·Sd′(f)/(m+n)). The obtained value should be saved by overwriting in the database.

If, as a result of seeking degrees of concurrence, a speech organ shape that surpasses the prescribed degree of concurrence is not registered, the speech organ shape estimated from the received waveform that was received by receiver 3 and S′(f) of the personal-use speech waveform that is estimated from S(f) of the speech waveform that was acquired by speech acquisition unit 7 should be newly added in correspondence with each other without obtaining the weighted mean.

According to another example of the database learning method, learning is realized by registering the speech organ shape that is estimated from the received waveform that was received by receiver 3 in the database in correspondence with the personal-use speech waveform that was acquired by personal-use speech acquisition unit 7′.

Learning unit 8 saves in the database a speech organ shape that is estimated from Rx(t) of the received waveform that was received by receiver 3 at the time of sound emission in correspondence with S′(t) of the personal-use speech waveform that was acquired by personal-use speech acquisition unit 7′ at the same time as the received waveform. If a speech organ shape that was estimated from a received waveform is already saved in the database at this time, S′(t) should be saved by overwriting as the corresponding personal-use speech waveform information. If a speech organ shape is not saved, this information and S′(t) should be newly added in correspondence with each other.

According to another possible method, learning unit 8 saves a speech organ shape that is estimated from Rx(f) of the received waveform that was received by receiver 3 at the time of sound emission in the database in correspondence with S′(f) of the personal-use speech waveform that was acquired by personal-use speech acquisition unit 7′ at the same time as the received waveform. If a speech organ shape that is estimated from a received waveform is already saved in the database at this time, S′(f) should be saved by overwriting as the corresponding personal-use speech waveform information. If a speech organ shape is not saved, this information and S′(f) should be newly added in correspondence with each other.

According to another example of the database learning method, updating is realized by obtaining the weighted mean of a personal-use speech waveform that is saved in the database that is searched from a speech organ shape that is estimated from the received waveform that was received by receiver 3 and the personal-use speech waveform that was acquired by personal-use speech acquisition unit 7′.

Learning unit 8 obtains the m:n weighted mean of S′(t) of the personal-use speech waveform that was acquired by personal-use speech acquisition unit 7′ and Sd′(t) of a personal-use speech waveform that is registered in the database in correspondence with the speech organ shape information that indicates the shape having the highest degree of concurrence with a speech organ shape that is estimated from the received waveform that was received by receiver 3 according to the following formula: (m·S′(t)+n·Sd′(t)/(m+n)). The obtained value is saved by overwriting in the database. If, as a result of seeking degrees of concurrence, a speech organ shape that surpasses the prescribed degree of concurrence is not registered, the speech organ shape that is estimated from the received waveform that was received by receiver 3 and S′(t) of the personal-use speech waveform that was acquired by personal-use speech acquisition unit 7′ should be newly added in correspondence with each other without obtaining the weighted mean.

Learning unit 8 obtains the m:n weighted mean of S′(f) of a personal-use speech waveform that was acquired by personal-use speech acquisition unit 7′ and Sd′(f) of a personal-use speech waveform that is registered in the database in correspondence with the speech organ shape information that indicates the shape having the highest degree of concurrence with the speech organ shape that is estimated from the received waveform that was received by receiver 3 according to the following formula: (m·S′(f)+n·Sd′(f)/(m+n)). The obtained value is saved by overwriting in the database. If, as a result of seeking degrees of concurrence, a speech organ shape that surpasses the prescribed degree of concurrence is not registered, the speech organ shape that is estimated from the received waveform that was received by receiver 3 and S′(f) of the personal-use speech waveform that was acquired by personal-use speech acquisition unit 7′ should be newly added in correspondence with each other without obtaining the weighted mean.

(18) Speech Organ Shape—Personal-Use Speech Correspondence Database

According to one example of this database learning method, learning is realized by registering a speech organ shape that is estimated from the received waveform that was received by receiver 3 in the database in correspondence with personal-use speech that is estimated from the speech waveform that was acquired by speech acquisition unit 7.

Learning unit 8 saves a speech organ shape that is estimated from Rx(t) of the received waveform that was received by receiver 3 at the time of sound emission in the database in correspondence with personal-use speech that is estimated from S(t) of the speech waveform that was acquired by speech acquisition unit 7 at the same time as the received waveform. If a speech organ shape that was estimated from the received waveform is already saved in the database at this time, the personal-use speech that is estimated from S(t) should be saved by overwriting as the corresponding personal-use speech information. If a speech organ shape is not saved, this information and the personal-use speech that is estimated from S(t) should be newly added in correspondence with each other.

According to another possible method, learning unit 8 saves a speech organ shape that is estimated from Rx(f) of the received waveform that was received by receiver 3 at the time of sound emission in the database in correspondence with personal-use speech that is estimated from S(f) of the speech waveforms that was acquired by speech acquisition unit 7 at the same time as the received waveform. If a speech organ shape that was estimated from the received waveform is already saved in the database at this time, the personal-use speech that is estimated from S(f) should be saved by overwriting as the corresponding personal-use speech information. If a speech organ shape is not saved, this information and personal-use speech that is estimated from S(f) should be newly added in correspondence with each other.

Examples of methods of estimating personal-use speech from the speech waveform that was acquired by speech acquisition unit 7 are here presented. There is a method of estimating personal-use speech after estimating speech from S(t) or S(f) of a speech waveform. There is a method of estimating personal-use speech after estimating S′(t) of a personal-use speech waveform from S(t) of a speech waveform. There is a method of estimating personal-use speech after estimating S′(f) of a personal-use speech waveform from S(f) of a speech waveform. At this time, a method in which each of parameters such as tone, sound volume, and voice quality is altered as already described can be used as the method of estimating personal-use speech from speech.

According to another example of this database learning method, updating is realized by obtaining the weighted mean of a personal-use speech waveform that is saved in the database that is searched from a speech organ shape that is estimated from the received waveform that was received by receiver 3 and personal-use speech that is estimated from the personal-use speech waveform that was acquired by personal-use speech acquisition unit 7′.

Learning unit 8 saves a speech organ shape that is estimated from Rx(t) of the received waveform that was received by receiver 3 at the time of sound emission in the database in correspondence with personal-use speech that is estimated from S′(t) of the personal-use speech waveform that was acquired by personal-use speech acquisition unit 7′ at the same time as the received waveform. When a speech organ shape that was estimated from received waveforms is already saved in the database at this time, personal-use speech estimated from S′(t) should be saved by overwriting as the corresponding personal-use speech information. If a speech organ shape is not saved, this information and S′(t) should be newly added in correspondence with each other.

Learning unit 8 saves a speech organ shape that is estimated from Rx(f) of the received waveform that was received by receiver 3 at the time of sound emission in the database in correspondence with personal-use speech that is estimated from S′(f) of the personal-use speech waveform that was acquired by personal-use speech acquisition unit 7′ at the same time as the received waveform. When a speech organ shape that was estimated from a received waveform is already saved in the database at this time, personal-use speech that is estimated from S′(f) should be saved by overwriting as the corresponding personal-use speech information. If a speech organ shape is not saved, this information and personal-use speech that is estimated from S′(f) should be newly added in correspondence with each other.

(19) Speech—Personal-Use Speech Waveform Correspondence Database

According to one example of this database learning method, learning is realized by registering speech that is estimated from the received waveform that was received by receiver 3 in the database in correspondence with a personal-use speech waveform that is estimated from the speech waveform that was acquired by speech acquisition unit 7.

Learning unit 8 saves speech that is estimated from Rx(t) of the received waveform that was received by receiver 3 at the time of sound emission in the database in correspondence with S′(t) of a personal-use speech waveform that is estimated from S(t) of the speech waveform that was acquired by speech acquisition unit 7 at the same time as the received waveform. If speech that was estimated from a received waveform is already saved in the database at this time, S′(t) should be saved by overwriting as the corresponding personal-use speech waveform information. If speech has not been saved, this information and S′(t) should be newly added in correspondence with each other.

Learning unit 8 saves speech that is estimated from Rx(f) of the received waveform that was received by receiver 3 at the time of sound emission in the database in correspondence with S′(f) of a personal-use speech waveform that is estimated from S(f) of the speech waveform that was acquired by speech acquisition unit 7 at the same time as the received waveform. If speech that was estimated from received waveforms is already saved in the database at this time, S′(f) should be saved by overwriting as the corresponding personal-use speech waveform information. If speech has not been saved, this information and S′(f) should be newly added in correspondence with each other.

According to another example of the database learning method, updating is realized by obtaining the weighted mean of a personal-use speech waveform that is saved in the database that is searched from speech that is estimated from the received waveform that was received by receiver 3 and a personal-use speech waveform that is estimated from the speech waveform that was acquired by speech acquisition unit 7.

Learning unit 8 obtains the m:n weighted mean of S′(t) of a personal-use speech waveform that is estimated from S(t) of the speech waveform that was acquired by speech acquisition unit 7 and Sd′(t) of a personal-use speech waveform that is registered in the database in correspondence with speech information that indicates the speech that has the highest degree of concurrence with speech that is estimated from the received waveform that was received by receiver 3 according to the formula: (m·S′(t)+n·Sd′(t)/(m+n)). The obtained value is saved by overwriting in the database. If, as a result of seeking degrees of concurrence, speech that surpasses the prescribed degree of concurrence is not registered, speech that is estimated from the received waveform that was received by receiver 3 and S′(t) of a personal-use speech waveform that is estimated from S(t) of the speech waveform that was acquired by speech acquisition unit 7 should be newly added in correspondence with each other without obtaining the weighted mean.

Learning unit 8 obtains the m:n weighted mean of S′(f) of a personal-use speech waveform that is estimated from S(f) of the speech waveform that was acquired by speech acquisition unit 7 and Sd′(f) of a personal-use speech waveform that is registered in the database in correspondence with the speech information that indicates speech having the highest degree of concurrence with speech that is estimated from the received waveform that was received by receiver 3 according to the formula: (m·S′(f)+n·Sd′(f)/(m+n)). The obtained value is saved by overwriting in the database. If, as a result of seeking degrees of concurrence, speech that surpasses the prescribed degree of concurrence is not registered, speech that is estimated from the received waveform that was received by receiver 3 and S′(f) of a personal-use speech waveform that is estimated from S(f) of the speech waveform that was acquired by speech acquisition unit 7 should be newly added in correspondence with each other without obtaining the weighted mean.

According to another example of this database learning method, learning is realized by registering speech estimated from the received waveform that was received by receiver 3 in the database in correspondence with the personal-use speech waveform that was acquired by personal-use speech acquisition unit 7′.

Learning unit 8 stores speech that is estimated from Rx(t) of the received waveform that was received by receiver at the time of sound emission in the database in correspondence with S′(t) of the personal-use speech waveform that was acquired by personal-use speech acquisition unit 7′ at the same time as received waveform. If speech that was estimated from received waveforms is already saved in the database at this time, S′(t) should be saved by overwriting as the corresponding personal-use speech waveform information. If speech has not been saved, this information and S′(t) should be newly added in correspondence with each other.

Learning unit 8 stores speech that is estimated from Rx(f) of the received waveform that was received by receiver 3 at the time of sound emission in the database in correspondence with S′(f) of the personal-use speech waveform that was acquired by personal-use speech acquisition unit 7′ at the same time as the received waveform. If speech that was estimated from the received waveform is already saved in the database at this time, S′(f) should be saved by overwriting as the corresponding personal-use speech waveform information. If speech has not been saved, this information and S′(f) should be newly added in correspondence with each other.

According to another example of the database learning method, updating is realized by obtaining the weighted mean of a personal-use speech waveform that is saved in the database that is searched from speech that is estimated from the received waveform that was received by receiver 3 and the personal-use speech waveform that was acquired by personal-use speech acquisition unit 7′.

Learning unit 8 obtains the m:n weighted mean of S′(t) of the personal-use speech waveform that was acquired by personal-use speech acquisition unit 7′ and Sd′(t) of a personal-use speech waveform that is registered in the database in correspondence with the speech information that indicates speech that has the highest degree of concurrence with speech that is estimated from the received waveform that was received by receiver 3 according to the formula: (m·S′(t)+n·Sd′(t)/(m+n)). The obtained value is saved by overwriting in the database. If, as a result of seeking degrees of concurrence, speech that surpasses the prescribed degree of concurrence is not registered, speech that is estimated from the received waveform that was received by receiver 3 and S′(t) of the personal-use speech waveform that was acquired by personal-use speech acquisition unit 7′ should be newly added in correspondence with each other without obtaining the weighted mean.

Learning unit 8 obtains the m:n weighted mean of S′(f) of the personal-use speech waveform that was acquired by personal-use speech acquisition unit 7′ and Sd′(f) of a personal-use speech waveform that is registered in the database in correspondence with the speech information that indicates speech that has the highest degree of concurrence with speech that is estimated from the received waveform that was received by receiver 3 in accordance with the formula: (m·S′(f)+n·Sd′(f)/(m+n)). The obtained value is saved by overwriting in the database. If, as a result of seeking degrees of concurrence, speech that surpasses the prescribed degree of concurrence is not registered, speech that is estimated from the received waveform that was received by receiver 3 and S′(f) of the personal-use speech waveform that was acquired by personal-use speech acquisition unit 7′ should be newly added in correspondence with each other without obtaining the weighted mean.

(20) Algorithm for Deriving Sound-Wave Transfer Functions

One algorithm learning method creates a transfer function that takes as input the received waveform that was received by receiver 3 and that takes as output the speech waveform that was acquired by speech acquisition unit 7 and that corrects the relations among each of the coefficients of the transfer function.

Learning unit 8 reports to speech estimation unit 4 information for designating the relations among each of the coefficients of the transfer function as information that indicates the transfer function derivation algorithm. Learning unit 8 may store a relational expression in a prescribed area that indicates the relations among each of the coefficients of the transfer function.

According to the present exemplary embodiment, learning unit 8 updates the various data used in estimation based on speech that is actually emitted and can therefore raise the estimation accuracy (i.e., the reproducibility of the speech). In addition, individual characteristics can be easily reflected.

The present invention according to the above-described exemplary embodiments can be used as shown below.

The present invention can be used for conversation by telephone in spaces that require concern for causing disturbance to other people and in which silence is called for such as on a public train. In such cases, it is assumed that the transmitter, receiver, and speech estimation unit or personal-use speech estimation unit are provided in a portable telephone.

When, on a public train, the portable telephone is held directed toward the mouth and the mouth is moved without emitting speech, the speech estimation unit of the portable telephone estimates the speech or speech waveforms. The portable telephone transmits the speech information realized by the estimated speech or speech waveforms to the partner telephone by way of the public network. When the speech estimation unit in the portable telephone estimates speech waveforms at this time, the portable telephone may execute steps identical to the steps for processing speech waveforms that are acquired by the microphone of a normal telephone to transmit to the partner telephone.

At this time, the portable telephone may reproduce by a speaker the speech or speech waveforms that have been estimated by the speech estimation unit or the personal-use speech estimation unit, whereby the owner of the portable telephone is able to confirm what he or she is voicelessly expressing and can thus use this feedback.

Alternatively, an application of the present invention can also be considered for providing a service in which, when singing a song by karaoke, one can sing the song in the voice of the professional singer of that song.

In this case, a transmitter and receiver are provided in the karaoke microphone and a speech estimation unit is provided in the main unit of the karaoke apparatus. In the speech estimation unit, each database or transfer function is registered to correspond to the speech or speech waveforms produced by the singer of each song. Then, using this karaoke apparatus, when the mouth is moved in time to the music while directed toward the microphone, the voice of the professional singer of that song will be supplied from the speaker by means of the operations described in the exemplary embodiments and examples. In this way, even an ordinary individual is able to experience the sensation of singing a song in the voice of a professional singer.

The program for executing the speech estimation method of the present invention may be recorded on a recording medium that can be read by a computer.

Although the invention of the present application has been explained with reference to exemplary embodiments and examples, the invention of the present application is not limited to the above-described exemplary embodiments and examples. The configuration and details of the invention of the present application are open to various alterations within the scope of the invention of the present application that will be clear to one expert in the art.

This application incorporates all of the content of Japanese Patent Application No. 2006-313309, for which application was submitted Nov. 20, 2006, and claims the priority of that Japanese Application.

1. A speech estimation system for estimating speech or speech waveforms from shape or movement of speech organs, said speech estimation system comprising:
a transmitter for transmitting a test signal toward the speech organs;
a receiver for receiving a reflection signal from the speech organs of said test signal that is transmitted by said transmitter; and
a speech estimation unit that includes a received wave-form-speech waveform estimation unit for estimating speech or speech waveforms from a received waveform, which is the waveform of a reflection signal received by said receiver.

2. (canceled)

3. (canceled)

4. (canceled)

5. The speech estimation system according to claim 1 wherein:
the received waveform-speech waveform estimation unit includes a waveform conversion filter unit for converting the received waveform to a speech waveform using a prescribed waveform conversion process; and
said received waveform-speech waveform estimation unit takes the speech waveform that was converted by said waveform conversion filter unit as the estimation result.

6. The speech estimation system according to claim 5, wherein said waveform conversion filter unit converts the received waveform to a speech waveform to at least one process of an arithmetic process with a specific waveform, a matrix arithmetic process, a filter process, or a frequency shift process as a waveform conversion process.

7. The speech estimation system according to claim 1 wherein:
the received waveform-speech waveform estimation unit includes a reflection waveform-speech waveform correspondence database for storing speech waveform information, which indicates waveforms of speech waveforms, that is corresponded to reflection waveform information, which indicates the waveforms of a reflection signal of a test signal at speech organs; and
said received waveform-speech waveform estimation unit searches said reflection waveform-speech waveform correspondence database for reflection waveform information that indicates the waveform having the highest degree of concurrence with the waveform of the received waveform and takes as estimation result the speech waveform indicated by speech waveform information that was placed in correspondence with the reflection waveform information.

8. The speech estimation system according to claim 1, wherein said speech estimation unit includes a received waveform-speech estimation unit for estimating speech from a received waveform that is the waveform of the reflection signal that is received by the receiver.

9. The speech estimation system according to claim 8, wherein:
the received waveform-speech estimation unit includes a reflection waveform-speech correspondence database for storing speech information, which indicates speech, that is corresponded to reflection waveform information that indicates the waveform of the reflection signal of the test signal at speech organs; and
said received waveform-speech estimation unit searches said reflection waveform-speech correspondence database for reflection waveform information that indicates the waveform having the highest degree of concurrence with the waveform of a received waveform and takes as the estimation result the speech indicated by the speech information that was placed in correspondence with the reflection waveform information.

10. The speech estimation system according to claim 8 wherein the received waveform-speech estimation unit comprises:
a received waveform-speech organ shape estimation unit for estimating the shape of speech organs from a received waveform that is the waveform of the reflection signal received by the receiver; and
a speech organ shape-speech estimation unit for estimating speech from the shape of the speech organs that is estimated by said received waveform-speech organ shape estimation unit.

11. The speech estimation system according to claim 10, wherein:
the speech organ shape-speech estimation unit includes a speech organ shape-speech waveform database for storing speech information, which indicates speech, that is corresponded to speech organ shape information that indicates the shape of speech organs; and
said speech organ shape-speech estimation unit searches said speech organ shape-speech correspondence database for speech organ shape information that indicates the shape having the highest degree of concurrence with the shape of the speech organs that was estimated by the received waveform-speech organ shape estimation unit, and takes as the estimation result speech that is indicated by the speech information that was placed in correspondence with the speech organ shape information.

12. The speech estimation system according to claim 8, wherein:
the speech estimation unit includes a speech-speech waveform estimation unit for estimating a speech waveform from speech; and
said speech-speech waveform estimation unit estimates a speech waveform from speech that was estimated by the received waveform-speech estimation unit.

13. The speech estimation system according to claim 12, wherein:
the speech-speech waveform estimation unit includes a speech-speech waveform correspondence database for storing speech waveform information, which indicates speech waveforms, that is corresponded to speech information, which indicates speech; and
said speech-speech waveform estimation unit searches said speech-speech waveform correspondence database for speech information that indicates speech having the highest degree of concurrence with speech that was estimated by the received waveform-speech estimation unit and takes as the estimation result the speech waveform indicated by the speech waveform information that was placed in correspondence with the speech information.

14. The speech estimation system according to claim 1, wherein the received waveform-speech waveform estimation unit includes:
a received waveform-speech organ shape estimation unit for estimating the shape of speech organs from a received waveform that is the waveform of a reflection signal received by the receiver; and
a speech organ shape-speech waveform estimation unit for estimating a speech waveform from the shape of speech organs that is estimated by said received waveform-speech organ shape estimation unit.

15. The speech estimation system according to claim 14, wherein:
said speech organ shape-speech waveform estimation unit includes a basic sound source information database for storing information of a sound source; and
said speech organ shape-speech waveform estimation unit derives a transfer function of sound in speech organs from the vocal chords to outside the mouth, which is emitted to speech waveform using the shape of speech organs that was estimated by the received waveform-speech organ shape estimation unit, and assigns the derived transfer function to a sound source that is registered in said basic sound source information database as the input waveform, and takes the output waveform that is obtained by calculation as the speech waveform that is the estimation result.

16. The speech estimation system according to claim 14, wherein:
the speech organ shape-speech waveform estimation unit includes a speech organ shape-speech waveform correspondence database for storing speech waveform information, which indicates speech waveforms, that is corresponded to speech organ information, which indicates shapes of speech organs; and
said speech organ shape-speech waveform estimation unit searches said speech organ shape-speech waveform correspondence database for speech organ shape information that indicates the shape having the highest degree of concurrence with the shape of speech organs that was estimated by the received waveform-speech organ shape estimation unit, and takes as the estimation result the speech waveform indicated by the speech waveform information that is placed in correspondence with the speech organ shape information.

17. The speech estimation system according to claim 10, wherein:
the received waveform-speech organ shape estimation unit includes a reflection waveform-speech organ shape correspondence database for storing speech organ shape information, which indicates shapes of speech organs, that is corresponded to reflection waveform information, which indicates waveforms of the reflection signal of the test signal at speech organs; and
said received waveform-speech organ shape estimation unit searches said reflection waveform-speech organ shape correspondence database for reflection waveform information that indicates the waveform having the highest degree of concurrence with the waveform of a received waveform, and takes as the estimation result the shape of speech organs that is indicated by speech organ shape information that was placed in correspondence with the reflection waveform information.

18. The speech estimation system according to claim 10, wherein the received waveform-speech organ shape estimation unit infers the distance to each reflection point in speech organs from received waveforms and estimates the shape of the speech organs from the positional relations of reflectors indicated by the distances to each reflection point.

19. The speech estimation system according to claim 1, comprising:
an image acquisition unit for acquiring images that contain at least a portion of the face of the person that is the object of estimation;
an image analysis unit for analyzing images acquired by said image acquisition unit, and for extracting an analyzed characteristic quantity that is a characteristic quantity regarding the shape or movement of speech organs that is obtained from images;
an analyzed characteristic quantity-speech estimation unit for estimating speech from an analyzed characteristic quantity that was extracted by said image analysis unit; and
an estimated speech correction unit for using speech that is estimated from an analyzed characteristic quantity by said analyzed characteristic quantity-speech estimation unit to correct speech that is estimated from received waveforms by the speech estimation unit.

20. The speech estimation system according to claim 19, wherein:
the analyzed characteristic quantity-speech estimation unit includes an analyzed characteristic quantity-speech correspondence database for storing speech information, which indicates speech, that is corresponded to characteristic quantity information, which indicates characteristic quantities for shapes or movements of speech organs; and
said analyzed characteristic quantity-speech estimation unit searches said analyzed characteristic quantity-speech correspondence database for characteristic quantity information that indicates the characteristic quantity having the highest degree of concurrence with the analyzed characteristic quantity that was extracted by the image analysis unit and takes as the estimation result speech that is indicated by speech information that was placed in correspondence with the characteristic quantity information.

21. The speech estimation system according to claim 19, wherein:
the estimated speech correction unit includes an estimated speech database for storing speech information, which indicates speech after correction, that is corresponded to a combination of speech information, which indicates speech that is estimated from an analyzed characteristic quantity, and speech information, which indicates speech that is estimated from received waveforms; and
said estimated speech correction unit searches said estimated speech database for speech information that indicates the combination having the highest degree of concurrence with the combination of speech that was estimated from a received waveform by the speech estimation unit and speech that was estimated from an analyzed characteristic quantity by the analyzed characteristic quantity-speech estimation unit, and that takes as the correction result speech that is indicated by speech information that indicates speech after correction that was placed in correspondence with the combination of speech information.

22. The speech estimation system according to claim 1, comprising:
an image acquisition unit for acquiring images that contain at least a portion of the face of the person that is the object of estimation;
an image analysis unit for analyzing images acquired by said image acquisition unit and extracting an analyzed characteristic quantity that is a characteristic quantity regarding the shape or movement of speech organs that is obtained from images;
an analyzed characteristic quantity-speech estimation unit for estimating the shape of speech organs from an analyzed characteristic quantity that was extracted by said image analysis unit; and
an estimated speech organ shape correction unit for using the shape of speech organs that is estimated from an analyzed characteristic quantity by said analyzed characteristic quantity-speech organ shape estimation unit to correct the shape of speech organs that is estimated from a received waveform by the speech estimation unit.

23. The speech estimation system according to claim 22, wherein the analyzed characteristic quantity-speech organ shape estimation unit takes an analyzed characteristic quantity that was extracted by said image analysis unit as the shape of speech organs that is the estimation result.

24. The speech estimation system according to claim 22, wherein:
said estimated speech organ shape correction unit includes an estimated speech organ shape database for storing speech organ shape information, which indicates the shapes of speech organs after correction in that is corresponded to combinations of speech organ shape information, which indicates shapes of speech organs that are estimated from analyzed characteristic quantities and speech organ shape information, which indicates the shapes of speech organs that are estimated from received waveforms; and
said estimated speech organ shape correction unit searches said estimated speech organ shape database for speech organ shape information that indicates the combination having the highest degree of concurrence with the combination of the shape of speech organs that was estimated from a received waveform and the shape of speech organs that was estimated from an analyzed characteristic quantity, and takes as the correction result the shape of speech organs that was indicated in speech organ shape information that indicates the shape of speech organs after correction that was placed in correspondence with the combination of speech organ shape information.

25. The speech estimation system according to claim 22, wherein the estimated speech organ shape correction unit corrects the shape of speech organs by carrying out a prescribed weighting of the shape of speech organs that was estimated from a received waveform and the shape of speech organs that was estimated from an analyzed characteristic quantity and calculating the weighted mean.

26. The speech estimation system according to claim 19, wherein the image acquisition unit acquires images of at least one of: the entire face and the mouth.

27. The speech estimation system according to claim 19, wherein the image analysis unit extracts information for specifying at least one of the facial expression, action of the mouth, movement of lips, movement of teeth, movement of tongue, outline of lips, outline of teeth, and outline of tongue from images acquired by the image acquisition unit.

28. The speech estimation system according to claim 1, comprising:
a first speech estimation unit for estimating speech or speech waveforms from a received signal; and
a second speech estimation unit for estimating speech or speech waveforms for personal use as speech or speech waveforms to be heard by the speaker.

29. The speech estimation system according to claim 28, wherein the second speech estimation unit includes a speech-personal-use speech waveform estimation unit for estimating personal-use speech waveforms from speech that is estimated from a received signal by the first speech estimation unit.

30. The speech estimation system according to claim 29, wherein:
the speech-personal-use speech waveform estimation unit includes a speech-personal-use speech waveform correspondence database for storing personal-use speech waveform information that indicates personal-use speech waveforms in correspondence with speech information that indicates speech; and
said speech-personal-use speech waveform estimation unit searches said speech-personal-use speech waveform correspondence database for speech information that indicates speech having the highest degree of concurrence with speech that is estimated by the speech estimation unit, and takes as the estimation result a speech waveform that is indicated by personal-use speech waveform information that was placed in correspondence with the speech information.

31. The speech estimation system according to claim 28, wherein the second speech estimation unit includes a speech-personal-use speech estimation unit for estimating personal-use speech from speech that is estimated from received waveforms by the first speech estimation unit.

32. The speech estimation system according to claim 31, wherein:
the speech-personal-use speech estimation unit includes a speech-personal-use speech correspondence database for storing personal-use speech information, which indicates personal-use speech, that is corresponded to speech information, which indicates speech; and
said speech-personal-use speech estimation unit searches said speech-personal-use speech correspondence database for speech information that indicates speech having the highest degree of concurrence with speech that is estimated by the first speech estimation unit and takes as the estimation result speech that is indicated by personal-use speech information that was placed in correspondence with the speech information.

33. The speech estimation system according to claim 28, wherein the second speech estimation unit includes a speech organ shape-personal-use speech waveform estimation unit for estimating a personal-use speech waveform from the shape of speech organs that is estimated from a received waveform by the first speech estimation unit.

34. The speech estimation system according to claim 33, wherein:
the speech organ shape-personal-use speech waveform estimation unit includes a speech organ shape-transfer function correction information database for storing correction information, which indicates correction content of transfer functions of sound, that is corresponded to speech organ shape information, which indicates the shapes of speech organs; and
said speech organ shape-personal-use speech waveform estimation unit: searches said speech organ shape-transfer function correction information database for speech organ shape information that indicates the shape having the highest degree of concurrence with the shape of speech organs that is estimated by said first speech estimation unit; based on the correction information that is placed in correspondence with the speech organ shape information, corrects a transfer function that is derived based on shapes of speech organs that are estimated by said first speech estimation unit; and uses the transfer function that was corrected to estimate a personal-use speech waveform.

35. The speech estimation system according to claim 1, comprising:
a speech acquisition unit for acquiring speech when the person that is the object of estimation is producing sound; and
a learning unit for updating various types of data that are used in estimation by the speech estimation unit using a temporal waveform of speech that is acquired by said speech acquisition unit and the received waveform at that time.

36. The speech estimation system according to claim 35, wherein the learning unit updates speech waveform information that is stored in correspondence with the received waveform of the time that the speech acquisition unit acquired the temporal waveform of speech based on the temporal waveform of speech that was acquired by said speech acquisition unit.

37. The speech estimation system according to claim 35, wherein the learning unit updates speech information that is stored in correspondence with the received waveform of the time that the speech acquisition unit acquired the temporal waveform of speech based on speech that is estimated from the temporal waveform of speech that was acquired by said speech acquisition unit.

38. The speech estimation system according to claim 35, wherein the learning unit, based on the temporal waveform of speech acquired by the speech acquisition unit and the received waveform at that time, calculates parameters of a transfer function by which is found said speech waveform that is acquired by a transfer function that is derived from said received waveform and registers information indicating the relation.

39. A speech estimation system according to claim 1, wherein the transmitter and receiver are incorporated in any one of a telephone, earphone, headset, decorative accessory, and glasses.

40. The speech estimation system according to claim 1, wherein at least one of the transmitter and receiver is incorporated in an apparatus that requires personal authentication.

41. (canceled)

42. (canceled)

43. The speech estimation system according to claim 1, wherein the speech acquisition unit is incorporated in any one of a telephone, earphone, headset, decorative accessory, or glasses.

44. A speech estimation method for estimating speech or speech waveforms from shape or movement of speech organs, comprising:
transmitting a test signal toward the speech organs;
receiving the reflection signal of said test signal at the speech organs; and
estimating speech or a speech waveform from said reflection signal that was received.

45. (canceled)

46. (canceled)

47. (canceled)

48. (canceled)

49. (canceled)

50. (canceled)

51. A speech estimation system for estimating speech or speech waveforms from shape or movement of speech organs, comprising:
a transmitter for transmitting a test signal toward the speech organs;
a receiver for receiving a reflection signal from the speech organs of a test signal that is transmitted by said transmitter;
a database for storing reflection signals and speech waveforms in correspondence with each other; and
a speech estimation unit for referring to said database for a reflection signal that is received by said receiver and supplying the corresponding speech waveform as the waveform of vocalization.

52. The speech estimation system according to claim 51, wherein speech waveforms stored in said database are waveforms of speech that is heard by someone other than the speaker or waveforms of speech that is heard by the speaker.

53. A speech estimation method for estimating speech or speech waveforms from shape or movement of speech organs, said speech estimation method comprising:
transmitting a test signal toward the speech organs;
receiving a reflection signal from the speech organs of the test signal that is transmitted by said transmitter;
storing reflection signals and speech waveforms in correspondence with each other; and
referring to said database for a reflection signal that is received by said receiver and supplying the corresponding speech waveform as the waveform of vocalization.

54. The speech estimation method according to claim 53, wherein speech waveforms stored in said database are waveforms of speech that is heard by someone other than the speaker or waveforms of speech that is heard by the speaker.
